(19) United States
(12) Patent Application Publication
(10) Pub. No.: US 2007/0288953 A1
(43) Pub. Date: Dec. 13, 2007

(54) SYSTEM AND METHOD FOR AUCTIONING AVAILS

(76) Inventors: Patrick M. Sheeman, Jamison, PA (US); Daniel C. Wilson, Edmonton (CA)

Correspondence Address: MARSH, FISCHMANN & BREYFOGLE LLP, 3151 SOUTH VAUGHN WAY, SUITE 411, AURORA, CO, 80014, US

(21) Appl. No.: 11/761,965

(22) Filed: Jun. 12, 2007

Related U.S. Application Data
(60) Provisional application No. 60/804,459, filed on Jun. 12, 2006.

(51) Int. Cl. H04N 7/025

(52) U.S. Cl. 725/34

(57) ABSTRACT

A system and method is provided for use in connection with auctioning delivery spots (e.g., ad spots) or commercial impressions in a broadcast network. The system provides (1702) information regarding asset delivery spots and receives (1704) bids from asset providers. A winning bidder is determined (1706), and a corresponding asset is delivered (1908) via the internet

### CROSS-REFERENCE

This application claims priority under 35 U.S.C. 119 to U.S. Provisional Application No. 60/804,459, entitled: “ADVATAR AND AUCTIONS,” filed on Jun. 12, 2006, the contents of which are incorporated herein as if set forth in full.

### FIELD

Systems and methods presented herein relate to the provision of targeted assets via a network interface. In one specific arrangement, targeted advertising media delivery spots are auctioned to asset providers (e.g., advertisers).

### BACKGROUND

Broadcast network content or programming is commonly provided in conjunction with associated informational content or assets. These assets include advertisements, associated programming, public-service announcements, ad tags, trailers, weather or emergency notifications and a variety of other content, including paid and unpaid content. In this regard, assets providers (e.g., advertisers) who wish to convey information (e.g., advertisements) regarding services and/or products to users of the broadcast network often pay for the right to insert their information into programming of the broadcast network. For instance, advertisers may provide ad content to a network operator such that the ad content may be interleaved with broadcast network programming during one or more programming breaks The delivery of such paid assets often subsidizes or covers the costs of the programming provided by the broadcast network. This may reduce or eliminate costs borne by the users of the broadcast network programming.

In order to achieve a better return on their investment, asset providers often try to target their assets to a selected audience that is believed to be interested in the goods or services of the asset provider. The case of advertisers on a cable television network is illustrative. For instance, an advertiser or a cable television network may desire to target its ads to certain demographic groups based on, for example, geographic location, gender, age, income etc. Accordingly, once an advertiser has created an ad that is targeted to a desired group of viewers (e.g., targeted group) the advertiser may attempt to procure insertion times in the network programming when the targeted group is expected to be among the audience of the network programming.

The inventors of the present application have recognized that systems that allow for obtaining information regarding current network users and/or the ability to dynamically insert assets (e.g., ad content) into one or more content streams may allow asset providers to more effectively match their assets to targeted network users. Further, the inventors have recognized that the ability to, inter alia, obtain current information and/or dynamically insert assets into one or more content streams of a broadcast network may facilitate additional functionalities for targeted advertising. For instance, in one aspect, functionality is provided for auctioning asset delivery spots (e.g., avails), an audience segment of an avail, or an aggregated audience (e.g., aggregated across multiple avails and/or multiple bandwidth segments or channels), to asset providers. Such auctioning may be done interactively prior to specific avails and/or in an automated process.

According to a first aspect of the present invention, a method and apparatus (utility) is provided for use in auctioning specific avails in a broadcast content stream. Generally the utility is utilized in connection with delivering assets to users of a broadcast network that is primarily utilized for synchronized distribution of broadcast content to multiple users. The utility involves providing information regarding an available asset delivery spot. Such information may be provided to a plurality of asset providers. Bids are then received for the asset delivery spot from one or more asset providers. Based upon a winning bid, an asset of one of the providers (e.g., the winning bidder) may be inserted into a content stream of the broadcast network for delivery during the asset delivery spot. Finally, a payment associated with the winning bid may be adjusted based upon information regarding the delivery of the asset to the users of the broadcast network. Such adjustment may be based upon the actual deliveries (e.g., total number of receiving users) and/or based upon statistical information associated with the estimated delivery of the asset to the users of the broadcast network.

The assets may include any assets of an asset provider, including, without limitation, advertising, programming, public service announcements, etc. Further, various steps and processes may be performed at different locations within a broadcast network. A number of these steps and processes may be performed at a location that is referred to as the headend of the network, which may generally entail any network components that are upstream (i.e., across a network interface) of customer premises equipment (CPE) or other user equipment devices (UEDs) (e.g., including mobile devices of a subscriber such as mobile televisions, data enabled phones and hard drive devise). Likewise, asset providers may be able to access one or more components of the system across one or more network interfaces for auctioning purposes.

Information regarding an available asset delivery spot may include temporal information regarding the asset delivery spot and/or network channel information for the asset delivery spot. In this regard, a time, location and/or program associated with the asset delivery spot may be provided. In a further arrangement, the information may include ratings information for programming associated with the asset delivery spot. Such ratings may include overall ratings for the programming and/or ratings that are arranged by one or more characteristics of network users that receive the programming. For instance, ratings may be provided that are arranged by different demographic groups of network users. In addition to providing ratings information, audience classification parameters may be provided with the asset delivery spot. For instance, such audience classification parameters may relate to age, gender, income, geographic local, and/or audience interest. In any case, asset providers may receive such information for use in determining the desirability of bidding on the asset delivery spot.

Receiving bids from the asset providers may include interactively receiving bids during a predetermined auctioning period in which asset providers may bid competitively with one another. In a further arrangement, receiving bids includes receiving predefined ad campaigns for one or more asset providers where such ad campaigns include one or more targeting criteria and bid information. In such an arrangement, the utility can correlate the targeting criteria and bid information of the predefined ad campaigns with information regarding an available asset delivery spot to identify a wining bid amongst a plurality of predefined ad campaigns. In this later arrangement, such bidding may be an automated process that is based on the predetermined criteria of various asset providers. The automation of the auction process may allow for performing auctions a short time prior to the asset delivery spot. For instance, such an auction may be performed during the program in which the asset delivery spot is included. In this regard, the system may be an on-the-fly or just-in-time auctioning system.

Inserting an asset of the winning asset provider may include replacing a default asset in the content delivery stream with the asset (i.e., winning asset) associated with the winning bidder. In another arrangement, inserting may include transmitting instructions to at least a portion of UEDs within the broadcast network to play the winning asset during the asset delivery spot. In such an arrangement, the winning asset may have been previously stored in storage facilities of the UEDs. In another arrangement, inserting may include inserting the asset associated with the winning bid into a parallel content stream that is broadcast in synchrony with a content stream that includes the asset delivery spot. In this regard, information may be provided to at least a portion of the UEDs in the broadcast network regarding the availability of the asset on the parallel content stream. Such information provided to the UEDs may include one or more targeting criteria for the asset. The UEDs can then switch to the asset on the parallel content stream during the asset delivery spot.

As will be further appreciated, utilization of parallel content streams may allow for inserting a second, third or more assets of additional asset providers (e.g., additional winning asset providers) into additional parallel content streams. Accordingly, the UEDs of the network users may be operative to select an appropriate asset for individual network users (e.g., based on a user profile stored by each UED). In this case, the different parallel asset insertion spots of the parallel content streams may be individually auctioned For instance, such individual auctions may be based on different demographics.

In order to adjust the payment associated with the winning bid, it may be useful to obtain information associated with the actual delivery of the asset of the winning asset provider(s). This may entail obtaining statistical information associated with the delivery of the asset to the network users. In another arrangement, users that actually receive the asset may provide a notification to the utility in order to determine an actual number of users who received the asset. In any case, the bid amount associated with the winning bid may be adjusted based on the delivery of the asset to network users. For instance, if the asset is delivered to a number of network users that is less then expected, the payment associated with the winning bid may be reduced, and vice versa.

The bidding mechanism may be based on a highest bid arrangement. That is, the bid that results in the greatest payment for the network provider may be utilized. However, it will be appreciated that any other applicable bidding system may be utilized. In this regard, a Vickery bidding system may be implemented in which the winning bidder pays a nominal (e.g., one penny) amount more than the second place bidder.

In accordance with another aspect of the present invention, a utility is provided that allows for auctioning multiple available asset delivery spots for a common avail. For example, a parallel content stream(s) may be utilized to deliver at least first and second different assets to first and second different sets of viewers of a common broadcast program. In this regard, the utility involves auctioning an asset delivery spot of a broadcast program that is to be broadcast to network audience to two or more asset providers (or potentially to a single asset provider). Typically, the auctioning is based on at least first and second audience characteristics (e.g., different demographics). Once completed, first and second assets associated with the winning bids are inserted in to one or more content streams of the broadcast network. Accordingly, during the broadcast of the program the first asset may be delivered to a first portion of the network audience and the second asset may be delivered to a second portion of the network audience during the asset delivery spot. In this regard, the first and second assets may be delivered simultaneously. In such an arrangement, the first and second assets may be delivered on separate broadcast content streams.

The characteristics of the audience may be any characteristics that may be readily defined. Such characteristics may include demographics and/or ratings. For instance, an auction based on ratings may allow for first and second asset providers to each provide their assets to, for example one-half of the audience. In this regard, the audience characteristic is a percentage of the total audience. More commonly, such characteristics may be based on demographics to allow for more specific targeting of members of the broadcast audience. The process of auctioning may involve performing a first auction for a first audience characteristic and performing a second auction for a second audience characteristic. In conjunction with auctioning, information may be provided regarding the asset delivery spot. Such information may include, without limitation, ratings and/or demographic information.

Delivering the first and second assets may include delivering a first asset within a content stream including the broadcast program and delivering the second asset on a parallel content delivery stream. Alternatively, both assets may be provided in parallel content streams. In any arrangement that utilizes parallel content streams, information may be provided to UEDs within the network to allow the UEDs to change between content streams based on, for example, audience classification parameters determined at the UEDs. Alternatively, the UEDs may randomly select between available assets for delivery during the asset delivery spot. For example, in instances were first and second asset providers have won one-half of the available network audience, the UEDs may be operative to select either or the first or second asset during the asset delivery spot. In any case, the UEDs may be operative to provide notification of the receipt and/or output of the first and/or second assets.

According to a further aspect of the present invention, a utility is provided for auctioning audience impressions. In this arrangement, audience impressions (e.g., delivery of an asset to a single household or network user of a household) may be auctioned to asset providers. The utility involves offering a predetermined number of audience impressions for an audience having at least one predefined targeting criteria. For example, a million impressions may be provided for a specific demographic, e.g., males between the ages of 18 and 24. The number of audience impressions may be provided within a set time period (e.g., 24 hours, 48 hours, etc.). Accordingly, the utility may receive bids for the audience impressions from one or more asset providers. Likewise, the asset of a winning asset provider may be delivered to network users having the at least one defined targeting criteria. Such targeting criteria may relate to demographic information such as age, gender, income, geographical location, etc.

Such delivery may be performed in a single asset delivery spot. In another arrangement, the delivery may be performed at temporally distinct times. For instance, the asset may be delivered at different asset delivery spots on a common network channel. In a further arrangement, the asset may be delivered on two or more different network channels and/or at two or more different times. In this regard, the asset may be delivered to a desired audience rather than at a specific time and/or on a specific channel. Asset providers may interactively bid for such audience impressions and/or provide predefined ad campaigns such that auctioning may be performed in an automated process.

According to another aspect of the invention, a just-in-time auctioning method is provided for auctioning upcoming asset delivery spots in a broadcast content stream. The utility includes obtaining at least one audience characteristic for an upcoming asset delivery spot in a broadcast content stream and identifying ad campaigns that have targeting criteria corresponding with the at least one audience characteristic. From the identified ad campaigns, a winning bid is identified and an asset associated with the winning ad campaign is delivered during the asset delivery spot. This process may be repeated for separate asset delivery spots. Alternatively, this process may be repeated for multiple parallel asset delivery spots for a common asset delivery spot.

Once an asset associated with the winning ad campaign is delivered, at least one parameter of that winning ad campaign may be adjusted based on the delivery of the asset. Such a parameter may include the number for impressions delivered for the winning ad campaign. In another arrangement, adjusting the parameter may include adjusting the costs (e.g., total costs) for the winning ad campaign. For instance, if an ad campaign has an available budget of one thousand dollars and the delivery of the asset during the asset delivery spot costs two hundred dollars, the two hundred dollars may be subtracted from the available budget to produce a remaining total of eight hundred dollars for future auctions.

In addition, information may be obtained regarding a number of network users who receive the asset such that, for example, the cost for delivery the asset may be based at least in part on the number of network users who receive the asset. In such an arrangement, the cost of delivering the asset may be determined by multiplying the number of network users who receive the asset with a bid price associated with the winning ad campaign. Obtaining information associated with number of network users who receive the asset may include obtaining statistical information and/or obtaining reports from UEDs of the network users who actually receive the asset.

The step of identifying ad campaigns may further include identifying constraints within the campaigns and correlating those constraints with the upcoming asset delivery spot. For instance, ad campaigns may have temporal targeting criteria that correspond with time(s) the asset providers wish to deliver their assets. Such temporal targeting criteria may include time of days, days of the week, start and end time (e.g., 8:00 am to 5:00 pm), minimum separation between repeated deliveries of the same asset etc. Further, constraints may include ad campaigns having programming targeting criteria that corresponds with programming associated with a given asset delivery spot. Such programming targeting criteria may include ratings, inclusions and or exclusions or particularly networks, program ratings (e.g., all viewers, adult content, etc.).

The process of determining a winning ad campaign may include multiplying a bid price associated with each ad campaign associated with the asset delivery spot to determine an offering price for each ad campaign for the asset delivery spot. In one arrangement, the winning ad campaign may be selected based on the highest offering price. It will be further appreciated that the estimated audience may be separated into different estimated audiences by demographic groups and a different bids of different ad campaigns may be multiplied by different estimated audiences to determine offering prices for each ad campaign. In this regard, different ad campaigns may be bidding on different demographic groups.

### BRIEF DESCRIPTION OF THE DRAWINGS

FIG. 1 illustrates major components of a cable television network.

FIG. 2 illustrates bandwidth usage that is dynamically determined on a geographically dependent basis via networks.

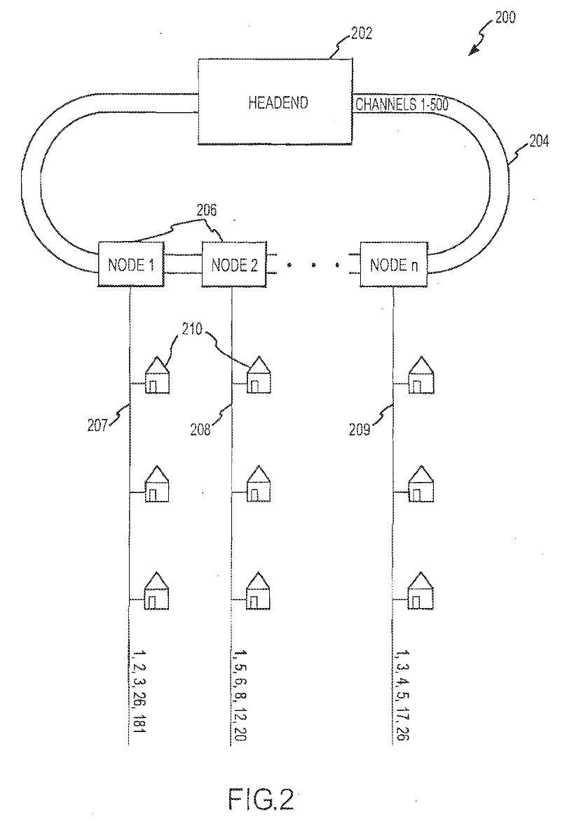

FIG. 3 illustrates asset insertion as accomplished at a headend.

FIG. 4 illustrates an exemplary audience shares of various networks as may be used to set asset delivery prices for future breaks associated with the program.

FIG. 5 illustrates delivery of assets to different users watching the same programming channel.

FIG. 6 illustrates audience aggregation across.

FIG. 7 illustrates a virtual channel in the context of audience aggregation.

FIG. 8 illustrates targeted asset insertion being implemented at Customer Premises Equipment (UEDs).

FIG. 9 illustrates asset options being transmitted from a headend on separate asset channels.

FIG. 10 illustrates a messaging sequence between a UED, a network platform, and a traffic and billing (T&B) system.

FIG. 11 is a flow chart illustrating a process for implementing time-slot and targeted impression buys.

FIG. 12 illustrates exemplary sequences associated with breaks on programming channels.

FIG. 13 illustrates an application that is supported by signals from UEDs and which provides targeted assets to users of one or more channels within a network.

FIG. 14 illustrates the use of asset channels for providing assets during a break of a programming channel.

FIG. 15 illustrates a reporting system.

FIG. 16 illustrates an auctioning platform incorporated into a targeted asset system.

FIG. 17 is a flow chart illustrating a first auction technique.

FIG. 18 is a flow chart illustrating a second auction technique.

FIG. 19 is a flow chart illustrating a third auction technique.

### DETAILED DESCRIPTION

The present invention relates to various structure and functionality for delivery of targeted assets, classification of network users or consuming patterns, and network monitoring for use in a communications network, as well as associated business methods. The invention is applicable with respect to networks where content is broadcast to network users; that is, the content is made available via the network to multiple users without being specifically addressed to individual user nodes in point-to-point fashion. In this regard, content may be broadcast in a variety of networks including, for example, cable and satellite television networks, satellite radio networks, IP networks used for multicasting content and networks used for podcasts or telephony broadcasts/multicasts. Content may also be broadcast over the airwaves though, as will be understood from the description below, certain aspects of the invention make use of bi-directional communication channels which are not readily available, for example, in connection with conventional airwave based televisions or radios (i.e., such communication would involve supplemental communication systems). In various contexts, the content may be consumed in real time or stored for subsequent consumption. Thus, while specific examples are provided below in the context of a cable television network for purposes of illustration, it will be appreciated that the invention is not limited to such contexts but, rather, has application to a variety of networks and transmission modes.

The targeted assets may include any type of asset that is desired to be targeted to network users. It is noted that such targeted assets are sometimes referred to as “addressable” assets (though, as will be understood from the description below, targeting can be accomplished without addressing in a point-to-point sense). For example, these targeted assets may include advertisements, internal marketing (e.g., information about network promotions, scheduling or upcoming events), public service announcements, weather or emergency information, or programming. The targeted assets may be independent or included in a content stream with other assets such as untargeted network programming. In the latter case, the targeted assets may be interspersed with untargeted programming (e.g., provided during programming breaks) or may otherwise be combined with the programming as by being superimposed on a screen portion in the case of video programming. In the description below, specific examples are provided in the context of targeted assets provided during breaks in television programming. While this is an important commercial implementation of the invention, it will be appreciated that the invention has broader application. Thus, distinctions below between “programming” and “assets” such as advertising should not be understood as limiting the types of content that may be targeted or the contexts in which such content may be provided.

The following description is divided into a number of sections. In the Introduction section, the broadcast network and network programming environments are first described. Thereafter, an overview of the targeted asset environment is provided including a discussion of certain shortcomings of the conventional asset delivery paradigm. The succeeding section describes components of a targeted asset system in accordance with aspects of the present invention highlighting advantages of certain preferred implementations thereof. Finally, the last section describes various structure and functionality for implementing auctioning of delivery spots and/or commercial impressions.

I. Introduction

A. Broadcast Networks

The present invention has particular application in the context of networks primarily used to provide broadcast content, herein termed broadcast networks. Such broadcast networks generally involve synchronized distribution of broadcast content to multiple users. However, it will be appreciated that certain broadcast networks are not limited to synchronously pushing content to multiple users but can also be used to deliver content to specific users, including on a user pulled basis. As noted above, examples of broadcast networks include cable television networks, satellite television networks, and satellite radio networks. In addition, audio, video or other content may be broadcast across Internet protocol and telephony networks. In any such networks, it may be desired to insert targeted assets such as advertisements into a broadcast stream. Examples of broadcast networks used to delivery content to specific users include broadcast networks used to deliver on demand content such as VOD and podcasts. The present invention provides a variety of functionality in this regard, as will be discussed in detail below.

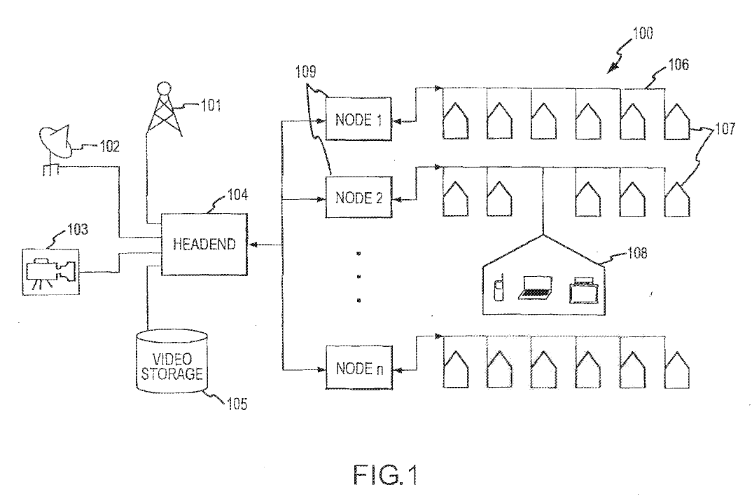

For purposes of illustration, the invention is described in some instances below in the context of a cable television network implementation. Some major components of a cable television network 100 are depicted in FIG. 1. In the illustrated network 100, a headend 104 obtains broadcast content from any of a number of sources 101-103. Additionally, broadcast content may be obtained from storage media 105 such as a via a video server. The illustrated sources include an antenna 101, for example, for receiving content via the airwaves, a satellite dish 102 for receiving content via satellite communications, and a fiber link 103 for receiving content directly from studios or other content sources. It will be appreciated that the illustrated sources 101-103 and 105 are provided for purposes of illustration and other sources may be utilized.

The headend 104 processes the received content for transmission to network users. Among other things, the headend 104 may be operative to amplify, convert and otherwise process the broadcast content signals as well as to combine the signals into a common cable for transmission to network users 107 (although graphically depicted as households, as described below, the system of the present invention can be used in implementations where individual users in a household are targeted). It also is not necessary that the target audience be composed households or household members in any sense. For example, the present invention can be used to create on-the-fly customized presentations to students in distributed classrooms, e.g., thus providing examples which are more relevant to each student or group of students within a presentation being broadcast to a wide range of students. The headend also processes signals from users in a variety of contexts as described below. The headend 104 may thus be thought of as the control center or local control center of the cable television network 100.

Typically, there is not a direct fiber link from the headend 104 to the customer premises equipment (CPE) 108. Rather, this connection generally involves a system of feeder cables and drop cables that define a number of system subsections or branches. This distribution network may include a number of nodes 109. The signal may be processed at these nodes 109 to insert localized content, filter the locally available channels or otherwise control the content delivered to users in the node area. The resulting content within a node area is typically distributed by optical and/or coaxial links 106 to the premises of particular users 107. Finally, the broadcast signal is processed by the UED 108 which may include a television, data terminal, a digital set top box, DVR or other terminal equipment. It will be appreciated that digital or analog signals may be involved in this regard.

Users employ the network, and network operators derive revenue, based on delivery of desirable content or programming. The stakeholders in this regard include programming providers, asset providers such as advertisers (who may be the same as or different than the programing providers), network operators such as Multiple Systems Operators (MSOs), and users—or viewers in the case of television networks. Programming providers include, for example: networks who provide series and other programming, including on a national or international basis; local affiliates who often provide local or regional programing; studios who create and market content including movies, documentaries and the like; and a variety of other content owners or providers. Asset providers include a wide variety of manufacturers, retailers, service providers and public interest groups interested in, and generally willing to pay for, the opportunity to deliver messages to users on a local, regional, national or international level. As discussed below, such assets include: conventional advertisements; tag content such as ad tags (which may include static graphic overlays, animated graphics files or even real-time video and audio) associated with the advertisements or other content; banners or other content superimposed on or otherwise overlapping programming; product placement; and other advertising mechanisms. In addition, the networks may use insertion spots for internal marketing as discussed above, and the spots may be used for public service announcements or other non-advertising content. Network operators are generally responsible for delivering content to users and otherwise operating the networks as well as for contracting with the networks and asset providers and billing. Users are the end consumers of the content. Users may employ a variety of types of UEDs including television, set top boxes, iPOD™ devices, data terminals, satellite delivered video or audio to an automobile, appliances (such as refrigerators) with built-in televisions, etc.

As described below, all of these stakeholders have an interest in improved delivery of content including targeted asset delivery. For example, users can thereby be exposed to assets that are more likely of interest and can continue to have the costs of programming subsidized or wholly borne by asset providers. Asset providers can benefit from more effective asset delivery and greater return on their investment. Network operators and asset providers can benefit from increased value of the network as an asset delivery mechanism and, thus, potentially enhanced revenues. The present invention addresses all of these interests.

It will be noted that it is sometimes unclear that the interests of all of these stakeholders are aligned. For example, it may not be obvious to all users that they benefit by consuming such assets. Indeed, some users may be willing to avoid consuming such assets even with an understanding of the associated costs. Network operators and asset providers may also disagree as to how programming should best be distributed, how asset delivery may be associated with the programming, and how revenues should be shared. As described below, the present invention provides a mechanism for accommodating potentially conflicting interests or for enhancing overall value such that the interests of all stakeholders can be advanced.

Assets can be provided via a variety of distribution modes including real-time broadcast distribution, forward-and-store, and on-demand delivery such as VOD. Real-time broadcast delivery involves synchronous delivery of assets to multiple users such as the conventional paradigm for broadcast radio or television (e.g., airwave, cable or satellite). The forward-and-store mode involves delivery of assets ahead of time to UEDs with substantial storage resources, e.g., a DVR or data terminal. The asset is stored for later display, for example, as prompted by the user or controlled according to logic resident at the UED and/or elsewhere in the communications network The on-demand mode involves individualized delivery of assets from the network to a user, often on a pay-per-view basis. The present invention can be utilized in connection with any of these distribution modes or others. In this regard, important features of the present invention can be implemented using conventional UEDs without requiring substantial storage resources to enhance even real-time broadcast programming, for analog and digital users.

The amount of programming that can be delivered to users is limited by the available programming space. This, in turn, is a function of bandwidth. Thus, for example, cable television networks, satellite television networks, satellite radio networks, and other networks have certain bandwidth limitations. In certain broadcast networks, the available bandwidth may be divided into bandwidth portions that are used to transmit the programming for individual channels or stations. In addition, a portion of the available bandwidth may be utilized for bi-directional messaging, metadata transmissions and other network overhead. Alternately, such bi-directional communication may be accommodated by any appropriate communications channels, including the use of one or more separate communications networks. The noted bandwidth portions may be defined by dedicated segments, e.g., defined by frequency ranges, or may be dynamically configured, for example, in the case of packetized data networks. As will be described below, in one implementation, the present invention uses available (dedicated or opportunistically available) bandwidth for substantially real time transmission of assets, e.g., for targeted asset delivery with respect to a defined asset delivery spot. In this implementation, bi-directional communications may be accommodated by dedicated messaging bandwidth and by encoding messages within bandwidth used for asset delivery. A DOCSIS path or certain TELCO solutions using switched IP may be utilized for bi-directional communications between the headend and UEDs and asset delivery to the UEDs, including real-time asset delivery, in the systems described below.

B. Scheduling

What programming is available on particular channels or other bandwidth segments at particular times is determined by scheduling. Thus, in the context of a broadcast television network, individual programming networks, associated with particular programming channels, will generally develop a programming schedule well into the future, e.g., weeks or months in advance. This programming schedule is generally published to users so that users can find programs of interest. In addition, this programming schedule is used by asset providers to select desired asset delivery spots.

Asset delivery is also scheduled. That is, breaks are typically built into or otherwise provided in programming content. In the case of recorded content, the breaks are pre-defined. Even in the case of live broadcasts, breaks are built-in. Thus, the number and duration of breaks is typically known in advance, though the exact timing of the breaks may vary to some extent. However, this is not always the case. For example, if sporting events go into overtime, the number, duration and timing of breaks may vary dynamically. As discussed below, the system of the present invention can handle real-time delivery of assets for updated breaks. In connection with regularly scheduled breaks, as discussed below, defined avail windows establish the time period during which certain breaks or spots occur, and a cue tone or cue message signals the beginning of such breaks or spots. In practice, an avail window may be as long as or longer than a program and include all associated breaks. Indeed, avail windows may be several hours long, for example, in cases where audience demographics are not expected to change significantly over large programming blocks. In this regard, an MSO may merge multiple avail windows provided by programming networks.

More specifically, a break may include a series of asset delivery spots and the content of a break may be determined by a number of entities. For example, some asset delivery is distributed on a basis coextensive with network programming, e.g., on a national basis. This asset delivery is conventionally scheduled based on a timed playlist. That is, the insertion of content is centrally controlled to insert assets at defined times. Accordingly, the programming and national asset delivery may be provided by the programming networks as a continuous content stream without cues for asset insertion. For example, prime-time programming on the major networks is often principally provided in this fashion.

In other cases, individual spots within a break are allocated for Regional Operations Center (ROC), affiliate, super headend or local (headend, zone) content. In these cases, a cue tone or message identifies the start of the asset delivery spot or spots (a series of assets in a break may all trigger from one cue). The cue generally occurs a few seconds before the start of the asset delivery insertion opportunity and may occur, for example, during programming or during the break (e.g., during a national ad). The system of the present invention can be implemented at any or all levels of this hierarchy to allow for targeting with respect to national, regional and local assets. In the case of regional or local targeted asset delivery, synchronous asset options (as discussed below) may be inserted into designated bandwidth in response to cues. In the case of national asset delivery, network signaling may be extended to provide signals identifying the start of a national spot or spots, so as to enable the inventive system to insert synchronous national asset options into designated bandwidth. For example, such signaling may be encrypted for use only by the inventive targeted asset system.

Network operators or local network affiliates can generally schedule the non-national assets to be included within defined breaks or spots for each ad-supported channel. Conventionally, this scheduling is finalized ahead of time, typically on a daily or longer basis. The scheduled assets for a given break are then typically inserted at the headend in response to the cue tone or message in the programming stream. Thus, for example, where a given avail window includes three breaks (each of which may include a series of spots), the scheduled asset for the first break is inserted in response to the first cue, the scheduled asset for the second break is inserted in response to the second cue, and the scheduled asset for the third break is inserted in response to the third cue. If a cue is missed, all subsequent assets within an avail window may be thrown off.

It will be appreciated that such static, daily scheduling can be problematic. For example, the programming schedule can often change due to breaking news, ripple effects from schedule over-runs earlier in the day or the nature of the programming. For example, certain live events such as sporting events are difficult to precisely schedule. In such cases, static asset delivery schedules can result in a mismatch of scheduled asset to the associated programming. For example, when a high value programming event such as a certain sporting event runs over the expected program length, it may sometimes occur that assets intended for another program or valued for a smaller audience may be shown when a higher value or better-tailored asset could have been used if a more dynamic scheduling regime were available. The asset targeting system allows for such dynamic scheduling as will be discussed in more detail below. The asset targeting system can also accommodate evolving standards in the field of dynamic scheduling.

C. The Conventional Asset Delivery Paradigm

Conventional broadcast networks may include asset-supported and premium content channels/networks. As noted above, programming content generally comes at a substantial cost. That is, the programming providers expect to be compensated for the programming that they provide which has generally been developed or acquired at significant cost. That compensation may be generated by asset delivery revenues, by fees paid by users for premium channels, or some combination of the two. In some cases, funding may come from another source such as public funding.

In the case of asset-supported networks, the conventional paradigm involves time-slot buys. Specifically, asset providers generally identify a particular program or time-slot on a particular network where they desire their assets to be aired. The cost for the airing of the asset depends on a number of factors, but one primary factor is the size of the audience for the programming in connection with which the asset is aired. Thus, the standard pricing model is based on the cost per thousand viewers (CPM), though other factors such as demographics or audience composition are involved as discussed below. The size of the audience is generally determined based on ratings. The most common benchmark for establishing these ratings is the system of Nielsen Media Research Corporation (Nielsen). One technique used by Nielsen involves monitoring the viewing habits of a presumably statistically relevant sampling of the universe of users. Based on an analysis of the sample group, the Nielsen system can estimate what portion of the audience particular programs received and, from this, an estimated audience size for the program can be projected. Thus, the historical performance of the particular program, for example, as estimated by the Nielsen system, may be used to set asset delivery prices for future breaks associated with that program.

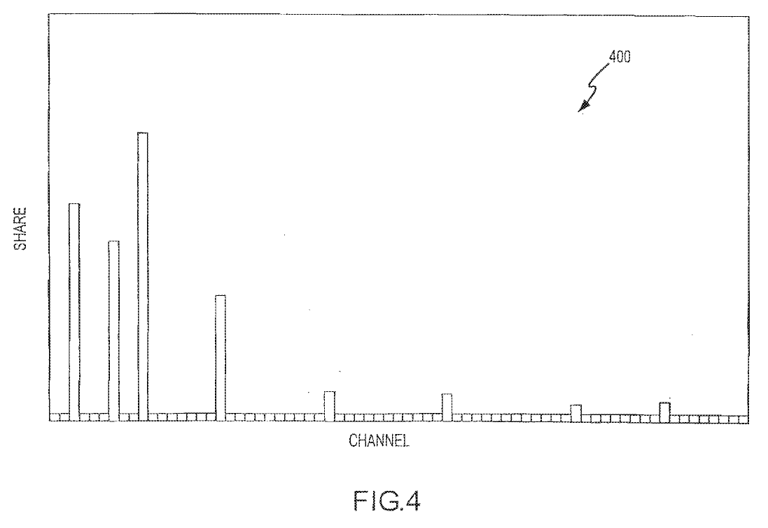

In practice, this results in a small number of programming networks being responsible for generating a large portion of the overall asset revenues. This is graphically depicted in FIG. 4 which generally illustrates this phenomenon, although it is not based on actual numbers. As shown in FIG. 4, it is often the case that three or four programming networks out of many available programming networks garner very large shares whereas the remaining programming networks have small or negligible share. Indeed, in some cases, many programming networks will have a share that is so small that it is difficult to statistically characterize based on typical Nielsen sampling group sizes. In these cases, substantial asset revenues may be generated in connection with the small number of programming networks having a significant share while very little revenue is generated with respect to the other programming networks. This is true even though the other programming networks, in the aggregate, may have a significant number of users in absolute terms. Thus, the conventional paradigm often fails to generate revenues commensurate with the size of the total viewing audience serviced by the network operator. As discussed below, this is a missed revenue opportunity that can be addressed in accordance with the present invention.

As noted above, the pricing for asset delivery depends on the size of the viewing audience and certain other factors. One of those factors relates to the demographics of interest to the asset provider. In this regard, a given program will generally have a number of different ratings for different demographic categories. That is, the program generally has not only a household rating, which is measured against the universe of all households with televisions, but also a rating for different demographic categories (e.g., males 18-24), measured against the universe of all members of the category who have televisions. Thus, the program may have a rating of 1 (1%) overall and a rating of 2 (2%) for a particular category. Typically, when asset providers buy a time-slot, pricing is based on a rating or ratings for the categories of interest to the asset provider. This results in significant inefficiencies due to poor matching of the audience to the desired demographics.

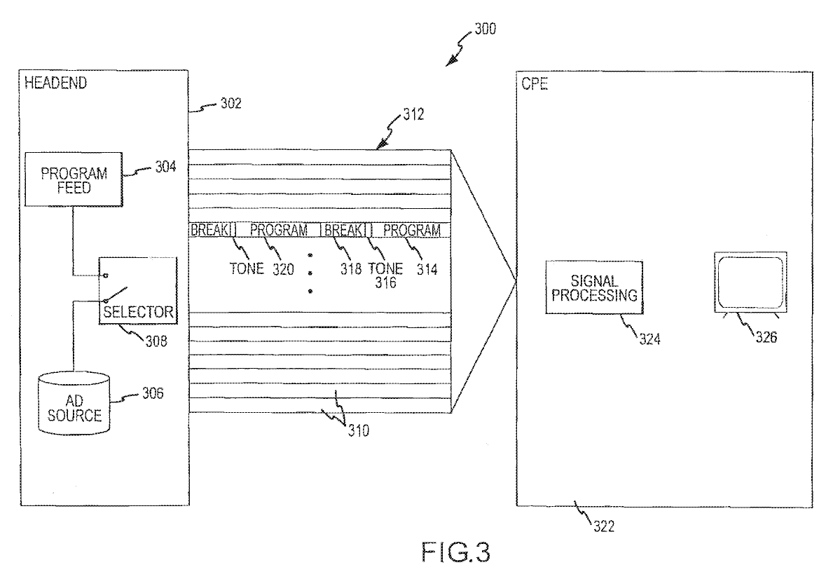

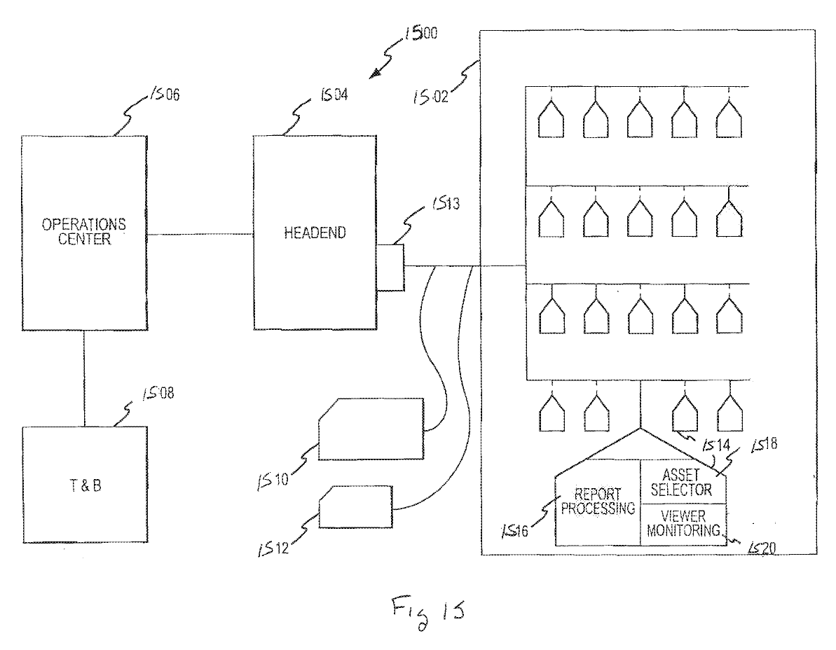

Conventionally, asset insertion is accomplished at the headend. This is illustrated in FIG. 3. In the illustrated system 300, the headend 302 includes a program feed 304 and an asset source 306. As noted above, the program feed 304 may be associated with a variety of programming sources such as video storage, an antenna, satellite dish or fiber feed from a studio or the like. The asset source 306 may include a tape library or other storage system for storing pre-recorded assets. A platform associated with the headend 302—in this case, denoted a selector 308—inserts programming from the program feed 304 and assets from the asset source 306 into the video stream of an individual channel 310. This is done for each channel to define the overall content 312 that is distributed to subscribers (or at least to a node filter). Typically, although not necessarily, the selector 308 effectively toggles between the program feed 304 and the asset source 306 such that the programming and assets are inserted in alternating, non-time overlapping fashion. Thus, as shown in FIG. 3, a particular channel may include a time segment 314 of programming followed by a cue tone 316 (which may occur, for example, during a programming segment, or during a time period of an asset provided with the programming stream, just prior to an insertion opportunity) to identify the initiation of a break 318. In response to the tone, the selector 308 is operative to insert assets into the programming stream for that channel. At the conclusion of the break 318, the selector 308 returns to the program feed to insert a further programming segment 320. An example of a timeline in this regard is shown in FIG. 15.

This content 312 or a filtered portion thereof is delivered to UEDs 322. In the illustrated embodiment the UED 322 is depicted as including a signal processing component 324 and a television display 326. It will be appreciated that these components 324 and 326 may be embodied in a single device and the nature of the functionality may vary. In the case of a digital cable user, the signal processing component 324 may be incorporated into a digital set top box (DSTB) for decoding digital signals. Such boxes are typically capable of bi-directional messaging with the headend 302 which will be a significant consideration in relation to functionality described below.

II. System Overview

A. The Targeted Asset Delivery Environment

Against this backdrop described in the context of the conventional asset delivery paradigm, a system embodying the present invention is described below. The inventive system, in the embodiments described below, allows for delivery of targeted assets such as advertising so as to address certain shortcomings or inefficiencies of conventional broadcast networks. Generally, such targeting entails delivering assets to desired groups of individuals or individuals having desired characteristics. These characteristics or audience classification parameters may be defined based on personal information, demographic information, psychographic information, geographic information, or any other information that may be relevant to an asset provider in identifying a target audience. Preferably, such targeting is program independent in recognition that programming is a highly imperfect mechanism for targeting of assets. For example, even if user analysis indicates that a particular program has an audience comprised sixty percent of women, and women comprise the target audience for a particular asset, airing on that program will result in a forty percent mismatch. That is, forty percent of the users potentially reached may not be of interest to the asset provider and pricing may be based only on sixty percent of the total audience. Moreover, ideally, targeted asset delivery would allow for targeting with a range of granularities including very fine granularities. For example, it may be desired to target a group, such as based on a geographical grouping, a household characterization or even an individual user characterization The present invention accommodates program independent targeting, targeting with a high degree of granularity and targeting based on a variety of different audience classifications.

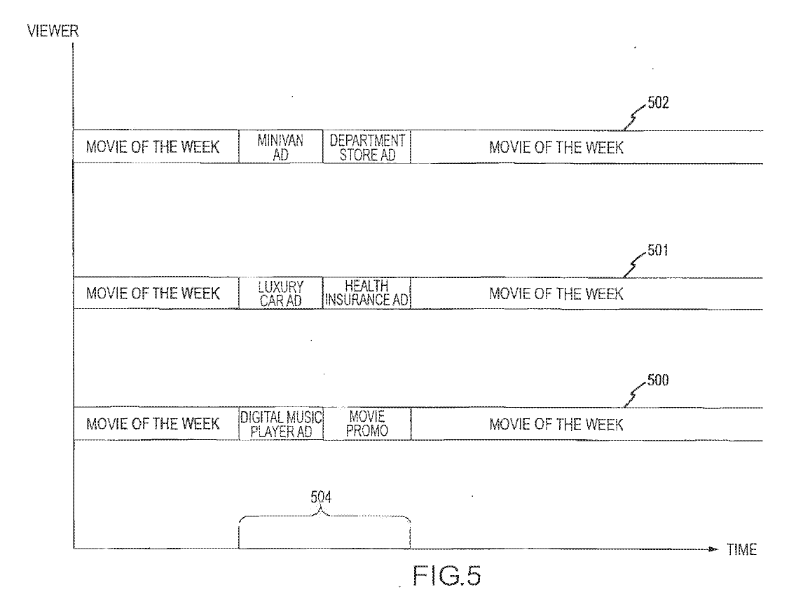

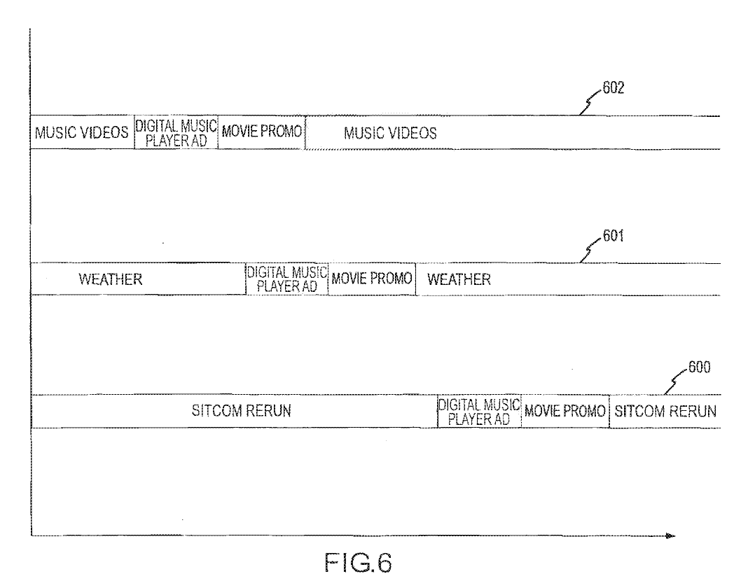

FIGS. 5 and 6 illustrate two different contexts of targeted asset delivery supported in accordance with the asset targeting system. Specifically, FIG. 5 illustrates the delivery of different assets, in this case ads, to different users watching the same programming channel, which may be referred to as spot optimization. As shown, three different users 500-502 are depicted as watching the same programming, in this case, denoted “Movie of the Week.” At a given break 504 the users 500-502 each receive a different asset package. Specifically, user 500 receives a digital music player ad and a movie promo, user 501 receives a luxury car ad and a health insurance ad, and user 502 receives a minivan ad and a department store ad. Alternately, a single asset provider (e.g., a motor vehicle company) may purchase a spot and then provide different asset options for the spot (e.g., sports car, minivans, pickup trucks, etc.). Similarly, separate advertisers may collectively purchase a spot and then provide ads for their respective products (e.g., where the target audiences of the advertisers are complementary). It will be appreciated that these different asset packages may be targeted to different audience demographics. In this manner, assets are better tailored to particular viewers of a given program who may fall into different demographic groups. Thus, spot optimization refers to the delivery of different assets (by one or multiple asset providers) in a given spot.

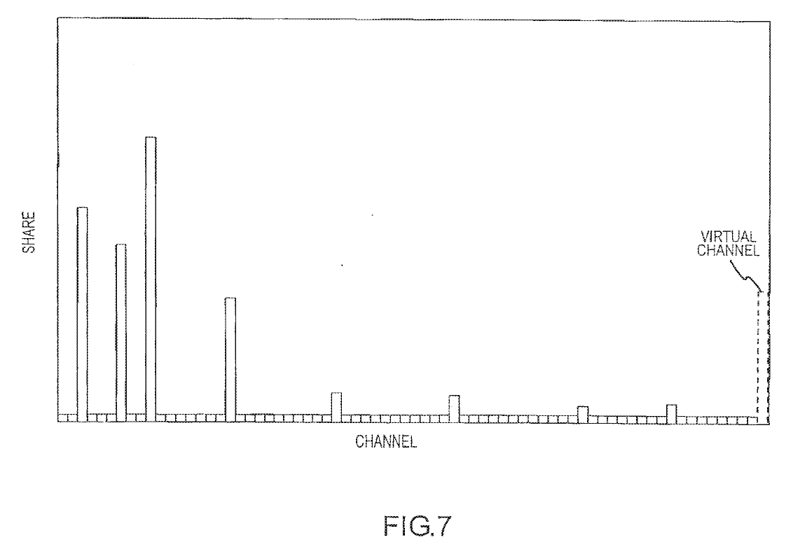

FIG. 6 illustrates a different context of the present invention, which may be termed audience aggregation. In this case, three different users 600-602 viewing different programs associated with different channels may receive the same asset or asset package. In this case, each of the users 600-602 receives a package including a digital music player ad and a movie promo in connection with breaks associated with their respective channels. Though the users 600-602 are shown as receiving the same asset package for purposes of illustration, it is likely that different users will receive different combinations of assets due to differences in classification parameters. In this manner, users over multiple channels (some or all users of each channel) can be aggregated (relative to a given asset and time window) to define a virtual channel having significant user numbers matching a targeted audience classification. Among other things, such audience aggregation allows for the possibility of aggregating users over a number of low share channels to define a significant asset delivery opportunity, perhaps on the order of that associated with one of the high share networks. This can be accomplished, in accordance with the present invention, using equipment already at a user's premises (i.e., an existing UED). Such a virtual channel is graphically illustrated in FIG. 7, though this illustration is not based on actual numbers. Thus, audience aggregation refers to the delivery of the same asset in different spots to define an aggregated audience. These different spots may occur within a time window corresponding to overlapping (conflicting) programs on different channels. In this manner, it is likely that these spots, even if at different times within the window, will not be received by the same users.

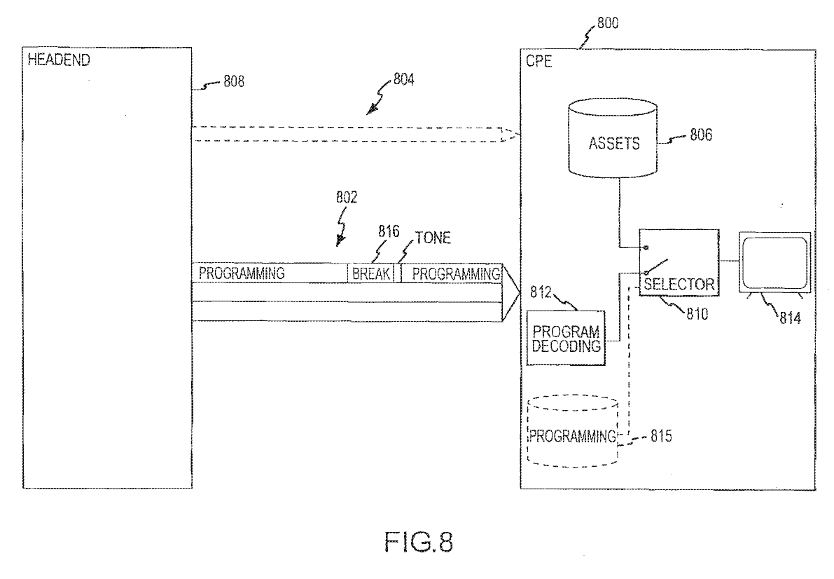

Such targeting including both spot optimization and audience aggregation can be implemented using a variety of architectures in accordance with the asset targeting system. Thus, for example, as illustrated in FIG. 8, targeted asset insertion can be implemented at the UEDs. This may involve a forward-and-store functionality. As illustrated in FIG. 8, the UED 800 receives a programming stream 802 and an asset delivery stream 804 from the headend 808. These streams 802 and 804 may be provided via a common signal link such as a coaxial cable or via separate communications links. For example, the asset delivery stream 804 may be transmitted to the UED 800 via a designated segment, e.g., a dedicated frequency range, of the available bandwidth or via a programming channel that is opportunistically available for asset delivery, e.g., when it is otherwise off air. The asset delivery stream 804 may be provided on a continuous or intermittent basis and may be provided concurrently with the programming stream 802. In the illustrated example, the programming stream 802 is processed by a program decoding unit, such as DSTB, and programming is displayed on television set 814. Alternatively, the programming stream 802 may be stored in programming storage 815 for UED insertion.

In the illustrated implementation, the asset, together with metadata identifying, for example, any audience classification parameters of the targeted audience, is stored in a designated storage space 806 of the UED 800. It will be appreciated that substantial storage at the UED 800 may be required in this regard. For example, such storage may be available in connection with certain digital video recorder (DVR) units. A selector 810 is implemented as a processor running logic on the UED 800. The selector 810 functions analogously to the headend selector described above to identify breaks 816 and insert appropriate assets. In this case, the assets may be selected based on classification parameters of the household or, more preferably, a user within the household. Such information may be stored at the UED 800 or may be determined based on an analysis of viewing habits such as a click stream from a remote control as will be described in more detail below. Certain aspects of the present invention can be implemented in such a UED insertion environment.

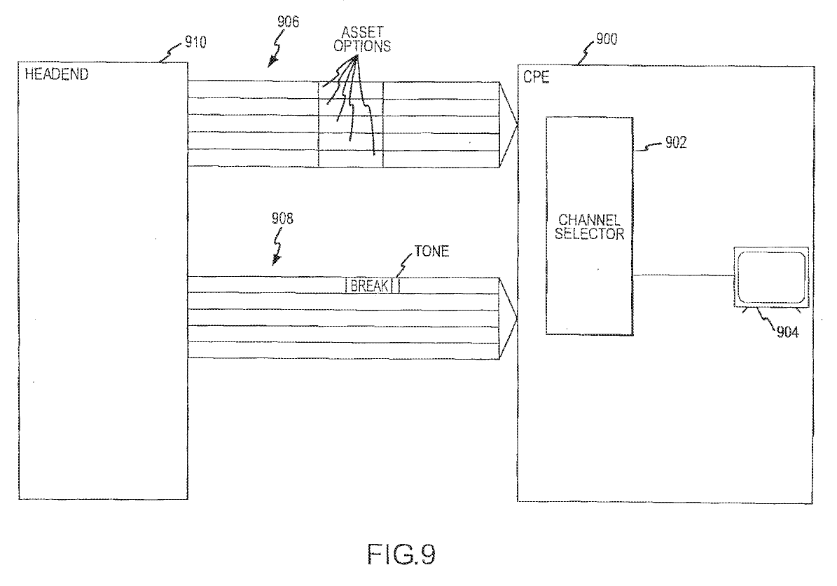

In FIG. 9, a different architecture is employed. Specifically, in FIG. 9, asset options transmitted from headend 910 synchronously with a given break on a given channel for which targeted asset options are supported. The UED 900 includes a channel selector 902 which is operative to switch to an asset channel associated with a desired asset at the beginning of a break and to return to the programming channel at the end of the break. The channel selector 902 may hop between channels (between asset channels or between an asset channel and the programming channel) during a break to select the most appropriate assets. In this regard, logic resident on the UED 900 controls such hopping to avoid switching to a channel where an asset is already in progress. As described below, this logic can be readily implemented, as the schedule of assets on each asset channel is known. Preferably, all of this is implemented invisibly from the perspective of the user of set 904. The different options may be provided, at least in part, in connection with asset channels 906 or other bandwidth segments (separate from programming channels 908) dedicated for use in providing such options. In addition, certain asset options may be inserted into the current programming channel 9O8. Associated functionality is described in detail below. The architecture of FIG. 9 has the advantage of not requiring substantial storage resources at the UED 900 such that it can be immediately implemented on a wide scale basis using equipment that is already in the field.

As a further alternative, the determination of which asset to show may be made at the headend. For example, an asset may be selected based on voting as described below, and inserted at the headend into the programming channel without options on other asset channels. This would achieve a degree of targeting but without spot optimization opportunities as described above. Still further, options may be provided on other asset channels, but the selection as between those channels may be determined by the headend. For example, information about a household or user (e.g., brand of car owned, magazines subscribed to, etc.) stored on the headend may be used to match an asset to a household or user. That information, which may be termed “marketing labels,” may be used by the headend to control which asset is selected by the UED. For example, the UED may be instructed that it is associated with an “ACME preferred” customer. When an asset is disseminated with ACME preferred metadata, the UED may be caused to select that asset, thereby overriding (or significantly factoring with) any other audience classification considerations. However, it will be appreciated that such operation may entail certain concerns relating to sensitive information or may compromise audience classification based targeting in other respects.

A significant opportunity thus exists to better target users whom asset providers may be willing to pay to reach and to better reach hard-to-reach users. However, a number of challenges remain with respect to achieving these objectives including: how to provide asset options within network bandwidth limitations and without requiring substantial storage requirements and new equipment at the user's premises; how to obtain sufficient information for effective targeting while addressing privacy concerns; how to address a variety of business related issues, such as pricing of asset delivery, resulting from availability of asset options and attendant contingent delivery; and how to operate effectively within the context of existing network structure and systems (e.g., across node filters, using existing traffic and billing systems, etc.).

From the foregoing it will be appreciated that various aspects of the invention are applicable in the context of a variety of networks, including broadcast networks. In the following discussion, specific implementations of a targeted asset system are discussed in the context of a cable television network. Though the system enhances viewing for both analog and digital users, certain functionality is conveniently implemented using existing DSTBs. It will be appreciated that, while these represent particularly advantageous and commercially valuable implementations, the invention is not limited to these specific implementations or network contexts.

B. System Architecture

In one implementation, the system of the present invention involves the transmission of asset options in time alignment or synchronization with other assets on a programming channel, where the asset options are at least partially provided via separate bandwidth segments, e.g. channels at least temporarily dedicated to targeted asset delivery. Although such options may typically be transmitted in alignment with a break in programming, it may be desired to provide options opposite continuing programming (e.g., so that only subscribers in a specified geographic area get a weather announcement, an emergency announcement, election results or other local information while others get uninterrupted programming). Selection as between the available options may implemented at the user's premises, as by a DSTB in this implementation. In this manner, asset options are made available for better targeting, without the requirement for substantial storage resources or equipment upgrades at the user's premises (e.g., as might be required for a forward-and-store architecture). Indeed, existing DSTBs can be configured to execute logic for implementing the system described below by downloading and/or preloading appropriate logic.

Because asset options are synchronously transmitted in this implementation, it is desirable to be efficient in identifying available bandwidth and in using that bandwidth. Various functionality for improved bandwidth identification, e.g., identifying bandwidth that is opportunistically available in relation to a node filter. Efficient use of available bandwidth involves both optimizing the duty cycle or asset density of an available bandwidth segment (i.e., how much time, of the time a bandwidth segment is available for use in transmitting asset options, is the segment actually used for transmitting options) and the value of the options transmitted. The former factor is addressed, among other things, by improved scheduling of targeted asset delivery on the asset channels in relation to scheduled breaks of the programming channels.

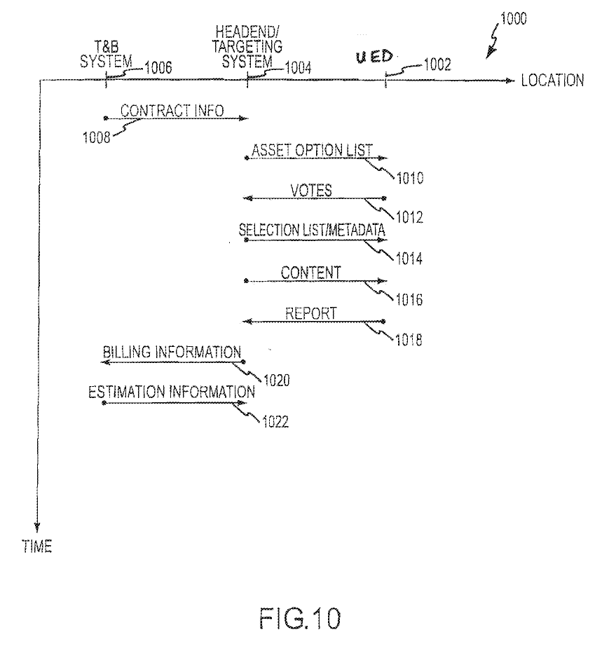

The latter factor is addressed in part by populating the available bandwidth spots with assets that are most desired based on current network conditions. These most desired assets can be determined in a variety of ways including based on conventional ratings. In the specific implementation described below, the most desired assets are determined via a process herein termed voting. FIG. 10 illustrates an associated messaging sequence 1000 in this regard as between a UED 1002 such as a DSTB, a network platform for asset insertion such as a headend 1004 and a traffic and billing (T&B) system 1006 used in the illustrated example for obtaining asset delivery orders or contracts and billing for asset delivery. It will be appreciated that the functionality of the T&B system 1006 may be split between multiple systems running on multiple platforms and the T&B system 1006 may be operated by the network operator or may be separately operated.

The illustrated sequence begins by loading contract information 1008 from the T&B system 1006 onto the headend 1004. An interface associated with system 1006 allows asset providers to execute contracts for dissemination of assets based on traditional time-slot buys (for a given program or given time on a given network) or based on a certain audience classification information (e.g., desired demographics, psychographics, geography, and/or audience size). In the latter case, the asset provider or network may identify audience classification information associated with a target audience. The system 1006 uses this information to compile the contract information 1008 which identifies the asset that is to be delivered together with delivery parameters regarding when and to whom the asset is to be delivered.

The illustrated headend 1004 uses the contract information together with a schedule of breaks for individual networks to compile an asset option list 1010 on a channel-by-channel and break-by-break basis. That is, the list 1010 lists the universe of asset options that are available for voting purposes for a given break on a given programming channel together with associated metadata identifying the target audience for the asset, e.g., based on audience classification information. The transmitted list 1010 may encompass all supported programming channels and may be transmitted to all participating users, or the list may be limited to one or a subset of the supported channels e.g., based on an input indicating the current channel or the most likely or frequent channels used by a particular user or group of users. The list 1010 is transmitted from the headend 1004 to the UED 1002 in advance of a break for which options are listed.

Based on the list 1010, the UED 1002 submits a vote 1012 back to the headend 1004. More specifically, the UED 1002 first identifies the classification parameters for the current user(s) and perhaps the current channel being watched, identifies the assets that are available for an upcoming break (for the current channel or multiple channels) as well as the target audience for those assets and determines a “fit” of one or more of those asset options to the current classification. In one implementation, each of the assets is attributed a fit score for the user(s), e.g., based on a comparison of the audience classification parameters of the asset to the putative audience classification parameters of the current user(s). This may involve how well an individual user classification parameter matches a corresponding target audience parameter and/or how many of the target audience parameters are matched by the user's classification parameters. Based on these fit scores, the UED 102 issues the vote 1012 indicating the most appropriate asset(s). Any suitable information can be used to provide this indication. For example, all scores for all available asset options (for the current channel or multiple channels) may be included in the vote 1012. Alternatively, the vote 1012 may identify a subset of one or more options selected or deselected by the UED 1002, with or without scoring information indicating a degree of the match and may further include channel information. In one implementation, the headend 1004 instructs UEDs (1002) to return fit scores for the top N asset options for a given spot, where N is dynamically configurable based on any relevant factor such as network traffic levels and size of the audience. Preferably, this voting occurs shortly before the break at issue such that the voting more accurately reflects the current status of network users. In one implementation, votes are only submitted for the programming channel to which the UED is set, and votes are submitted periodically, e.g., every fifteen minutes.

The headend 1004 compiles votes 1012 from UEDs 1002 to determine a set of selected asset options 1014 for a given break on a supported programming channel. As will be understood from the description below, such votes 1012 may be obtained from all relevant and participating UEDs 1002 (who may be representative of a larger audience including analog or otherwise non-participating users) or a statistical sampling thereof. In addition, the headend 1004 determines the amount of bandwidth, e.g., the number of dedicated asset option channels, that are available for transmission of options in support of a given break for a given programming channel.

Based on all of this information, the headend 1004 assembles a flotilla of assets, e.g., the asset options having the highest vote values or the highest weighted vote values where such weighting takes into account value per user or other information beyond classification fit. Such a flotilla may include asset options inserted on the current programming channel as well as on asset channels, though different insertion processes and components may be involved for programming channel and asset channel insertion. It will be appreciated that some assets may be assembled independently or largely independently of voting, for example, certain public service spots or where a certain provider has paid a premium for guaranteed delivery. Also, in spot optimization contexts where a single asset provider buys a spot and then provides multiple asset options for that spot, voting may be unnecessary (though voting may still be used to select the options).

In one implementation, the flotilla is assembled into sets of asset options for each dedicated asset channel, where the time length of each set matches the length of the break, such that channel hopping within a break is unnecessary. Alternatively, the UED 1002 may navigate between the asset channels to access desired assets within a break (provided that asset starts on the relevant asset channels are synchronized). However, it will be appreciated that the flotilla matrix (where columns include options for a given spot and rows correspond to channels) need not be rectangular. Stated differently, some channels may be used to provide asset options for only a portion of the break, i.e., may be used at the start of the break for one or more spots but are not available for the entire break, or may only be used after one or more spots of a break have aired. A list of the selected assets 1014 and the associated asset channels is then transmitted together with metadata identifying the target audience in the illustrated implementation. It will be appreciated that it may be unnecessary to include the metadata at this step if the UED 1002 has retained the asset option list 1010. This list 1014 is preferably transmitted shortly in advance of transmission of the asset 1016 (which includes sets of asset options for each dedicated contact options channel used to support, at least in part, the break at issue).

The UED 1002 receives the list of selected asset options 1014 and associated metadata and selects which of the available options to deliver to the user(s). For example, this may involve a comparison of the current audience classification parameter values (which may or may not be the same as those used for purposes of voting) to the metadata associated with each of the asset options. The selected asset option is used to selectively switch the UED 1002 to the corresponding dedicated asset options channel to display the selected asset 1016 at the beginning of the break at issue. One of the asset option sets, for example, the one comprised of the asset receiving the highest vote values, may be inserted into the programming channel so that switching is not required for many users. Assuming that the voting UEDs are at least somewhat representative of the universe of all users, a significant degree of targeting is thereby achieved even for analog or otherwise non-participating users. In this regard, the voters serve as proxies for non-voting users. The UED 1002 returns to the programming channel at the conclusion of the break. Preferably, all of this is transparent from the perspective of the user(s), i.e., preferably no user input is required. The system may be designed so that any user input overrides the targeting system. For example, if the user changes channels during a break, the change will be implemented as if the targeting system was not in effect (e.g., a command to advance to the next channel will set the UED to the channel immediately above the current programming channel, without regard to any options currently available for that channel, regardless of the dedicated asset channel that is currently sourcing the television output).

In this system architecture, as in forward-and-store architectures or any other option where selections between asset options are implemented at the UED, there will be some uncertainty as to how many users or households received any particular asset option in the absence of reporting. This may be tolerable from a business perspective. In the absence of reporting, the audience size may be estimated based on voting data, conventional ratings analysis and other tools. Indeed, in the conventional asset delivery paradigm, asset providers accept Nielsen rating estimates and demographic information together with market analysis to gauge return on investment. However, this uncertainty is less than optimal in any asset delivery environment and may be particularly problematic in the context of audience aggregation across multiple programming networks, potentially including programming networks that are difficult to measure by conventional means.

The system of the present invention preferably implements a reporting system by which individual UEDs 1002 report back to the headend 1004 what asset or assets were delivered at the UED 1002 and, optionally, to whom (in terms of audience classification). Additionally, the reports may indicate where (on what programming channel) the asset was delivered and how much (if any) of the asset was consumed. Such reports 1018 may be provided by all participating UEDs 1002 or by a statistical sampling thereof. These reports 1018 may be generated on a break-by-break basis, periodically (e.g., every 15 minutes) or may be aggregated prior to transmission to the headend 1004. Reports may be transmitted soon after delivery of the assets at issue or may be accumulated, e.g., for transmission at a time of day where messaging bandwidth is more available. Moreover, such reporting may be coordinated as between the UEDs 1002 so as to spread the messaging load due to reporting.

In any case, the reports 1018 can be used to provide billing information 1020 to the T&B system 1006 for valuing the delivery of the various asset options. For example, the billing information 1020 can be used by the T&B system 1006 to determine how large an audience received each option and how well that audience matched the target audience. For example, as noted above, a fit score may be generated for particular asset options based on a comparison of the audience classification to the target audience. This score may be on any scale, e.g., 1-100. Goodness of fit may be determined based on this raw score or based on characterization of this score such as “excellent,” “good,” etc. Again, this may depend on how well an individual audience classification parameter of a user matches a corresponding target audience parameter and/or how many of the target audience parameters are matched by the user's audience classification parameters. This information may in turn be provided to the asset provider, at least in an aggregated form. In this manner, the network operator can bill based on guaranteed delivery of targeted messages or scale the billing rate (or increase delivery) based on goodness of fit as well as audience size. The reports (and/or votes) 1018 can also provide a quick and detailed measurement of user distribution over the network that can be used to accurately gauge ratings, share, demographics of audiences and the like. Moreover, this information can be used to provide future audience estimation information 1022, for example, to estimate the total target universe based on audience classification parameters.

It will thus be appreciated that the present invention allows a network operator such as an MSO to sell asset delivery under the conventional asset delivery (time-slot) buy paradigm or under the new commercial impression paradigm or both. For example, a particular MSO may choose to sell asset delivery space for the major networks (or for these networks during prime time) under the old time-slot buy paradigm while using the commercial impression paradigm to aggregate users over multiple low market share networks. Another MSO may choose to retain the basic time-slot buy paradigm while accommodating asset providers who may wish to fill a given slot with multiple options targeted to different demographics. Another MSO may choose to retain the basic time-slot buy paradigm during prime time across all networks while using the targeted impression paradigm to aggregate users at other times of the day. The targeted impression paradigm may be used by such MSOs only for this limited purpose.

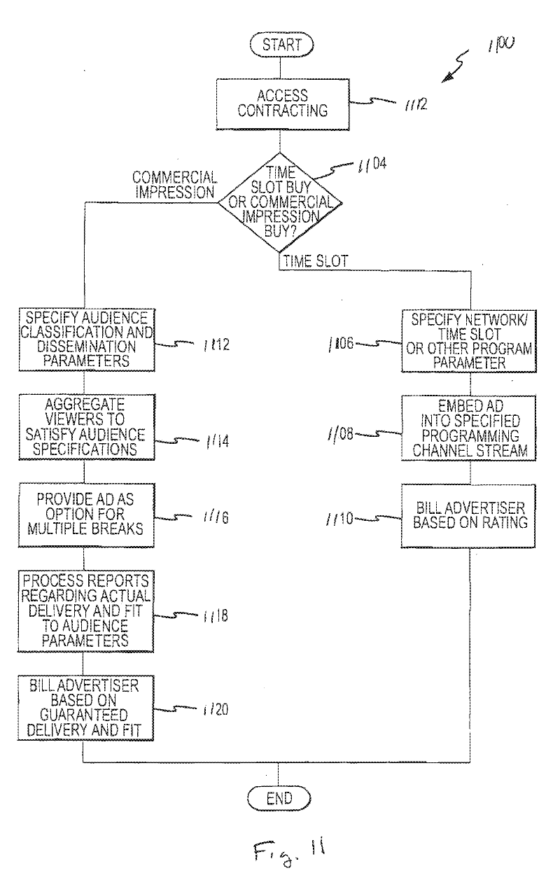

FIG. 11 is a flow chart illustrating an associated process 1100. An asset provider (or agent thereof) can initiate the illustrated process 1100 by accessing (1102) a contracting platform as will be described below. Alternatively, an asset provider can work with the sales department or other personnel of a system operator or other party who accesses such a platform. As a still further alternative, an automated buying system may be employed to interface with such a platform via a system-to-system interface. This platform may provide a graphical user interface by which an asset provider can design a dissemination strategy (e.g., an ad campaign) and enter into a corresponding contract for dissemination of an asset. The asset provider can then use the interface to select (1104) to execute either a time-slot buy strategy or a targeted impression buy strategy. In the case of a time-slot buy strategy, the asset provider can then use the user interface to specify (1106) a network and time-slot or other program parameter identifying the desired air times and frequency for delivery of the asset. Thus, for example, an asset provider may elect to air the asset in connection with specifically identified programs believed to have an appropriate audience. In addition, the asset provider may specify that the asset is to appear during the first break or during multiple breaks during the program. The asset provider may further specify that the asset is to be, for example, aired during the first spot within the break, the last spot within the break or otherwise designate the specific asset delivery slot.

Once the time-slots for the asset have thus been specified, the MSO causes the asset to be embedded (1108) into the specified programming channel asset stream. The asset is then available to be consumed by all users of the programming channel. The MSO then bills (1110) the asset provider, typically based on associated ratings information. For example, the billing rate may be established in advance based on previous rating information for the program in question, or the best available ratings information for the particular airing of the program may be used to bill the asset provider. It will thus be appreciated that the conventional time-slot buy paradigm is limited to delivery to all users for a particular time-slot on a particular network and does not allow for targeting of particular users of a given network or targeting users distributed over multiple networks in a single buy.

In the case of targeted impression buys, the asset provider can use the user interface as described in more detail below to specify (1112) audience classification and other dissemination parameters. In the case of audience classification parameters, the asset provider may specify the gender, age range, income range, geographical location, lifestyle interest or other information of a targeted audience. The additional dissemination parameters may relate to delivery time, frequency, audience size, or any other information useful to define a target audience. Combinations of parameters may also be specified. For example, an asset provider may specify an audience size of 100,000 in a particular demographic group and further specify that the asset is not delivered to any user who has already received the asset a predetermined number of times.

Based on this information, the targeted asset system of the present invention is operative to target appropriate users. For example, this may involve targeting only selected users of a major network. Additionally or alternatively, this may involve aggregating (1114) users across multiple networks to satisfy the audience specifications. For example, selected users from multiple programming channels may receive the asset within a designated time period in order to provide an audience of the desired size, where the audience is composed of users matching the desired audience classification. The user interface preferably estimates the target universe based on the audience classification and dissemination parameters such that the asset provider receives an indication of the likely audience size.

The aggregation system may also be used to do time of day buys. For example, an asset provider could specify audience classification parameters for a target audience and further specify a time and channel for airing of the asset. UEDs tuned to that channel can then select the asset based on the voting process as described herein. Also, asset providers may designate audience classification parameters and a run time or time range, but not the programming channel. In this manner, significant flexibility is enabled for designing a dissemination strategy. It is also possible for a network operator to disable some of these strategy options, e.g., for business reasons.

Based on this input information, the targeted asset system of the present invention is operative to provide the asset as an option during one or more time-slots of one or more breaks. In the case of spot optimization, multiple asset options may be disseminated together with information identifying the target audience so that the most appropriate asset can be delivered at individual UEDs. In the case of audience aggregation, the asset may be provided as an option in connection with multiple breaks on multiple programming channels. The system then receives and processes (1118) reports regarding actual delivery of the asset by UEDs and information indicating how well the actual audience fit the classification parameters of the target audience. The asset provider can then be billed (1120) based on guaranteed delivery and goodness of fit based on actual report information. It will thus be appreciated that a new asset delivery paradigm is defined by which assets are targeted to specific users rather than being associated with particular programs. This enables both better targeting of individual users for a given program and improved reach to target users on low-share networks.

From the foregoing, it will be appreciated that various steps in tile messaging sequence are directed to matching assets to users based on classification parameters, allowing for goodness of fit determinations based on such matching or otherwise depending on communicating audience classification information across the network. It is preferable to implement such messaging in a manner that is respectful of user privacy concerns and relevant regulatory regimes.

Much of the discussion above has referenced audience classification parameters as relating to individuals as opposed to households. Methods for identifying audience classification parameters are set forth in co-pending U.S. application Ser. No. 11/332,771, entitled, “VOTING AND HEADEND INSERTION,” the contents of which are incorporated herein by reference. In a first implementation, logic associated with the UED uses probabilistic modeling, fuzzy logic and/or machine learning to progressively estimate the audience classification parameter values of a current user or users based on the click stream. This process may optionally be supplemental based on stored information (preferably free of sensitive information) concerning the household that may, for example, affect probabilities associated with particular inputs. In this manner, each user input event (which involves one or more items of change of status and/or duration information) can be used to update a current estimate of the audience classification parameters based on associated probability values. The fuzzy logic may involve fuzzy data sets and probabilistic algorithms that accommodate estimations based on inputs of varying and limited predictive value.

In a second implementation, the click stream is modeled as an incomplete or noisy signal that can be processed to obtain audience classification parameter information. More specifically, a series of clicks over time or associated information can be viewed as a time-based signal. This input signal is assumed to reflect a desired signature or pattern that can be correlated to audience classification parameters. However, the signal is assumed to be incomplete or noisy—a common problem in signal processing. Accordingly, filtering techniques are employed to estimate the “true” signal from the input stream and associated algorithms correlate that signal to the desired audience classification information. For example, a nonlinear adaptive filter may be used in this regard.

One of the audience classifications that may be used for targeting is location. Specifically, an asset provider may wish to target only users within a defined geographic zone (e.g., proximate to a business outlet) or may wish to target different assets to different geographic zones (e.g., targeting different car ads to users having different supposed income levels based on location). In certain implementations, the present invention determines the location of a particular UED and uses the location information to target assets to the particular UED. It will be appreciated that an indication of the location of a UED contains information that may be considered sensitive. The present invention also creates, extracts and/or receives the location information in a manner that addresses these privacy concerns. This may also be accomplished by generalizing or otherwise filtering out sensitive information from the location information sent across the network. This may be accomplished by providing filtering or sorting features at the UED or at the headend. For example, information that may be useful in the reporting process (i.e. to determine the number of successful deliveries within a specified location zone) may be sent upstream with little or no sensitive information included. Additionally, such location information can be generalized so as to not be personally identifiable. For example, all users on a given block or within another geographic zone (such as associated with a zip plus 2 area) may be associated with the same location identifier (e.g., a centroid for the zone).

Similarly, it is often desired to associate tags with asset selections. Such tags are additional information that is superimposed on or appended to such assets. For example, a tag may provide information regarding a local store or other business location at the conclusion of an asset that is distributed on a broader basis. Conventionally, such tags have been appended to ads prior to insertion at the headend and have been limited to coarse targeting. In accordance with the present invention, tags may be targeted to users in particular zones, locations or areas, such as neighborhoods. Tags may also be targeted based on other audience classification parameters such as age, gender, income level, etc. For example, tags at the end of a department store ad may advertise specials on particular items of interest to particular demographics. Specifically, a tag may be included in an asset flotilla and conditionally inserted based on logic contained within the UED 1101. Thus the tags are separate units that can be targeted like other assets, however, with conditional logic such that they are associated with the corresponding asset.

Targeting may also be implemented based on marketing labels. Specifically, the headend may acquire information or marketing labels regarding a user or household from a variety of sources. These marketing labels may indicate that a user buys expensive cars, is a male 18-24 years old, or other information of potential interest to an asset provider. In some cases, this information may be similar to the audience classification parameters, though it may optionally be static (not varying as television users change) and based on hard data (as opposed to being surmised based on viewing patterns or the like). In other cases, the marketing labels may be more specific or otherwise different than the audience classification. In any event, the headend may inform the UED as to what kind of user/household it is in terms of marketing labels. An asset provider can then target an asset based on the marketing labels and the asset will be delivered by UEDs where targeting matches. This can be used in audience aggregation and spot optimization contexts.

Thus, the targeted asset system of the present invention allows for targeting of assets in a broadcast network based on any relevant audience classification, whether determined based on user inputs such as a click stream, based on marketing labels or other information pushed to the customer premises equipment, based on demographic or other information stored or processed at the headend, or based on combinations of the above or other information. In this regard, it is therefore possible to use, in the context of a broadcast network, targeting concepts that have previously been limited to other contexts such as direct mail. For example, such targeting may make use of financial information, previous purchase information, periodical subscription information and the like. Moreover, classification systems developed in other contexts, may be leveraged to enhance the value of targeting achieved in accordance with the present invention.

An overview of the system has thus been provided, including introductory discussions of major components of the system, which provides a system context for understanding the operation of those components.

III. Component Overview

A. Measurement and Voting

Generally, signals received from a UED 1002 are utilized by the present systems and methods for at least three separate applications, which in some instances may also be combined. See FIG. 10. These applications may be termed measurement, voting and reporting. Reporting is described in more detail below. Measurement relates to the use of the signals to identify the audience size and, optionally, the classification composition of the audience. This information assists in estimating the universe of users available for targeting, including an estimate of the size and composition of an audience that may be aggregated over multiple channels (e.g., including low share channels) to form a substantial virtual channel. Accordingly, a targeted asset may be provided for the virtual channel to enhance the number of users who receive the asset. Voting involves the use of signals received from UEDs 1012 to provide an asset based on asset performance indications from the UEDs. In any case, assets may be selected and inserted into one or more transmitted data streams based on signals received from one or more UEDs.

With regard to audience measurement, the two-way communication between the headend and UED allows for gathering information which may indicate, at least implicitly, information regarding audience size and audience classification composition. In this regard, individual UEDs may periodically or upon request provide a signal to the headend indicating, for example, that an individual UED is active and what channel is currently being displayed by the UED. This information, which may be provided in connection with voting, reporting on other messages (e.g., messages dedicated to measurement) can be used to infer audience size and composition. Wholly apart from the targeted asset system, such information may be useful to support ratings and share information or for any other audience measurement objective. Referring briefly to FIG. 7, it is noted that of the available programming channels, four programming channels have the largest individual share of users (e.g., the four major networks). However, there are numerous other users in the network albeit in smaller shares of the total on a channel-by-channel basis. By providing a common set of asset options to the users of two or more of the programming channels having a small market share (or even to users of programming channels with large shares), a virtual channel may be created. That is, a common asset option or set of asset options may be provided to an aggregated group from multiple programming channels. Once combined, the effective market share of a virtual channel composed of users from small share channels may approximate the market share of, for example, one of the four major networks.

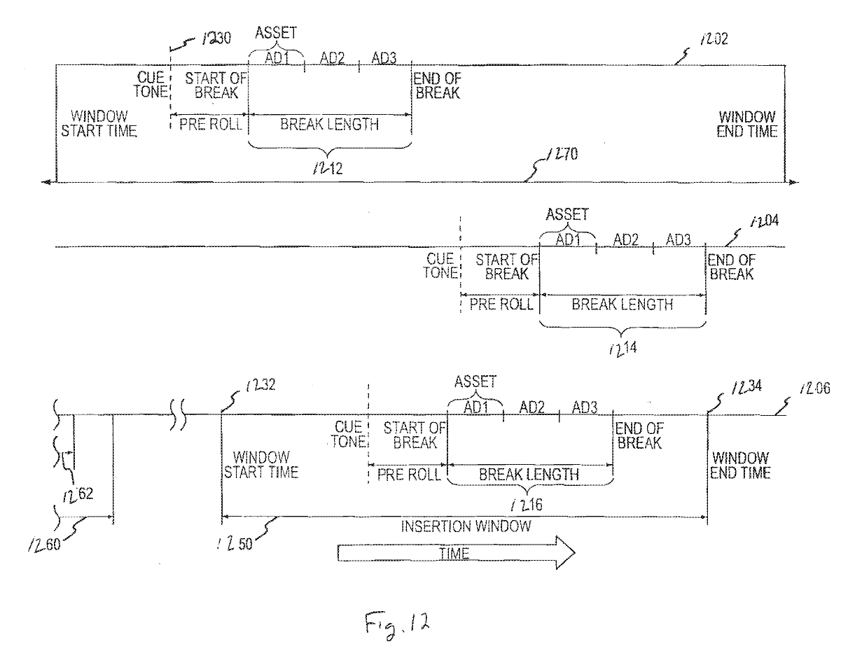

While the aggregation of the users of multiple programming channels into a virtual channel allows for providing a common set of asset options to each of the programming channels, it will be appreciated that the asset will generally be provided for each individual programming channel at different times. This is shown in FIG. 12 where two different programming channels (e.g., 1202 and 1204), which may be combined into a virtual channel, have different scheduled breaks 1212, 1214. In this regard, an asset may be provided on the first channel 1202 prior to when the same asset is provided on the second channel 1204. However, this common asset may still be provided within a predetermined time window (e.g., between 7 p.m. and 8 p.m.). In this regard, the asset may be delivered to the aggregated market share represented by the virtual channel (or a subset thereof) within defined constraints regarding delivery time. Alternatively, the size of such an aggregated audience may be estimated in advance based on previous reporting, ratings and census data, or any other technique. Thus measurement or voting is not necessary to accomplish targeting, though such detailed asset information is useful. Actual delivery may be verified by subsequent reporting. As will be appreciated, such aggregation allows a network operator to disseminate assets based on the increased market share of the virtual channel(s) in relation to any one of the subsumed programming channels, as well as allowing an asset provider to more effectively target a current viewing audience.

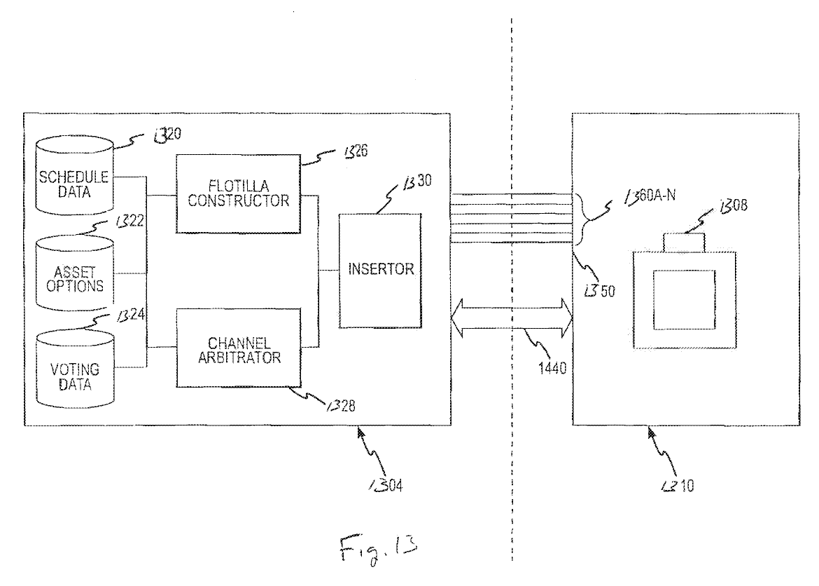

Another application that is supported by signals from UEDs is the provision of targeted assets to current users of one or more channels within the network, e.g., based on voting. Such an application is illustrated in FIG. 13, where, in one arrangement, signals received from UEDs 130 (only one shown) may be utilized to select assets (e.g., a break asset and/or programming) for at least one programming channel 1350. In this regard, such assets may be dynamically selected for insertion into the data stream of the programming channel 1350, for example, during a break or other designated time period. In a further arrangement, unused bandwidth of the network is utilized to provide parallel asset streams during a break or designated time period of the targeted channel 1350. In the context of a break, multiple asset channels 1360A-N may be used to provide asset options during a single break, wherein each asset channel 1360A-N may provide options directed to different groups of viewers and/or otherwise carry different assets (e.g., users having similar audience classification parameters may receive different assets due to a desired sequencing of packaged assets as discussed below).

In such an arrangement, the UED 1310 may be operative to select between alternate asset channels 1360A-N based on the signals from the UED 1360. In addition to targeted audience aggregation, such a system may be desirable to enhance revenues or impact for programming, including large share programming (spot optimization). That is, a single break may be apportioned to two or more different asset providers, or, a single asset provider may provide alternate assets where the alternate assets target different groups of users. Though discussed herein as being directed to providing different break or interstitial assets to different groups of users, it should be noted that the system may also be utilized to provide different programming assets.

An associated asset targeting system implementing a voting process is also illustrated in FIG. 13. The asset targeting system of FIG. 13 has a platform 1304, which includes a structure of the network (i.e., upstream from the users/households) that is operative to communicate with UEDs 1310 (only one shown) within the network. The illustrated UED 1310 includes a signal processing device 1308, which in the present illustration is embodied in a DSTB. Generally, the platform 1304 is operative to communicate with the UED 1310 via a network interface 1340. In order to provide parallel asset channels 1360A-N during a break of a programming channel, e.g., channel 1350, the platform 1304 is in communication with one or more of the following components: a schedule database 1320, an available asset option database 1322, voting database 1324, a flotilla constructor 1326, a channel arbitrator 1328, and an inserter 1330. Of note, the listed components 1320-1330 do not have to be located at a common network location. That is, the various components of the platform 1304 may be distributed over separate locations within the network and may be interconnected by any appropriate communication interfaces.

Generally, the schedule database 1320 includes information regarding the timing of breaks for one or more programming channels, the asset option database 1322 includes available asset metadata identifying the asset and targeted audience classification parameters, and the voting database 1324 includes voting information obtained from one or more UEDs for use in targeting assets. The actual assets are generally included in a separate database (not shown). The flotilla constructor 1326 is utilized to populate a break of a programming channel and/or asset channels 1360A-N with selected assets. The channel arbitrator 1328 is utilized to arbitrate the use of limited bandwidth (e.g., available asset channels 1360A-N) when a conflict arises between breaks of two or more supported programming channels. Finally, the inserter 1330 is utilized to insert selected assets or targeted assets into an asset stream (e.g., of a programming channel 1350 and or one or more asset channels 1360A-N) prior to transmitting the stream across the network interface 1340. As will be discussed herein, the system is operative to provide asset channels 1360A-N to support asset options for breaks of multiple programming channels within the network.

In order to provide asset channels 1360A-N for one or more programming channels, the timing of the breaks on the relevant programming channels is determined. For instance, FIG. 12 illustrates three programming channels that may be provided by the network operator to a household via a network interface. As will be appreciated, many more channels may also be provided. The channels 1202, 1204 and 1206 comprise three programming streams for which targeted assets are provided. Users may switch between each of these channels 1202, 1204 and 1206 (and generally many more) to select between programming options. Each channel 1202, 1204 and 1206 includes a break 1212, 1214 and 1216, respectively, during the programming period shown. During breaks 1212-1216 one or more asset spots are typically available. That is, a sequence of shorter assets may be used to fill the 90-second break. For example, two, three or four spots may be defined on a single channel for a single break. Different numbers of spots or avails may be provided for the same break on different channels and a different number of channels may be used for different portions of the break.

In order to provide notice of upcoming breaks or insertion opportunities within a break, programming streams often include a cue tone signal 1230 (or a cue message in digital networks) a predetermined time before the beginning of each break or insertion opportunity. These cue tone signals 1230 have historically been utilized to allow local asset providers to insert localized assets into a network feed. Further, various channels may provide window start times and window end times during which one or more breaks will occur. These start and end times define an avail window. Again, this information has historically been provided to allow local asset providers to insert local assets into a broadcast stream. This information may also be utilized by the targeted asset system to determine when a break will occur during programming. Accordingly, the system may be operative to monitor programming channels, e.g., 1202, 1204 and 1206, for cue tone signals 1230 as well as obtain and store information regarding window start and end times (e.g., in the schedule database 1320). The available window information may be received from the T&B system and may be manually entered.

Referring again to FIG. 13, the use of signals from the UED 1310 may allow for providing assets that are tailored to current users or otherwise for providing different assets to different groups of users. In this regard, an asset that has targeting parameters that match the classification parameters of the greatest number of users may be provided within the broadcast stream of a supported programming channel 1350 during a break. It is noted that the most appropriate asset may thereby be provided to analog or otherwise nonparticipating users (assuming the voters are representative of the relevant user universe), yielding a degree of targeting even for them. Moreover, some targeting benefit can be achieved for a large number of programming channels, even channels that may not be supported by asset channels with respect to a given break.

Alternatively or additionally, different assets may be provided on the asset channels 1360A-N during the break of a programming channel. During a break where asset channels 1360A-N are available, a UED 1310 of a particular household may, based on a determination implemented at the UED 1310, switch to one of the asset channels 1360A-N that contains appropriate assets. Accordingly, such assets of the asset channel 1360A-N may be displayed during the break. During the break, the UED 1310 may stay on one asset channel 1360A-N (in the case of a break with multiple spots in sequence) or may navigate through the break selecting the most appropriate assets. After the break, the UED 1310 may switch back to the original programming channel (if necessary). This switching may occur seamlessly from the point of view of a user. In this regard, different assets may be provided to different users during the same break. As will be appreciated, this allows asset providers to target different groups during the same break. Further it allows for a network operator to market a single spot to two different asset providers on an apportioned basis (or allow a single asset provider to fill a single spot with multiple asset options). Each asset provider may, for example, thereby pay for an audience that better matches its target.

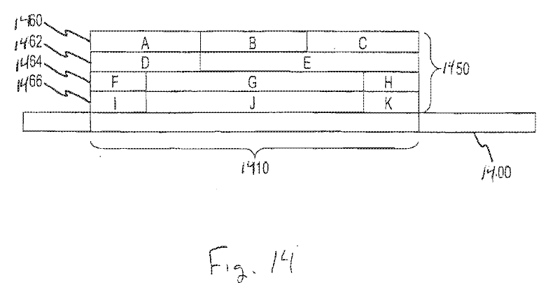

FIG. 14 illustrates the use of four asset channels 1401-l404 for providing a flotilla of assets during a break 1410 of a programming channel 1400. As shown, on each asset channel 1401-1404, the break 1410 may be separated into one or more asset slots that may have different durations. However, in the case of FIG. 14, the start and end times of the asset sets A-C, D-E, F-H and I-K carried by the asset channels 1401-1404 are aligned with the start and end times of the break 1410. Each of the asset channels 1401-1404 may carry an asset that is targeted to a specific audience classification of the users of the targeted channel 1400 or the users of additional programming channels having a break aligned with the break 1410 of the programming channel 1400.

It should be noted that flotillas need not be rectangular as shown in FIG. 14. That is, due to conflicts between breaks or the intermittent availability of certain asset channels as discussed above, the total number of asset channels used to support a given programming channel may change during a break. Each asset channel 1401-1404 includes a different combination of assets A-K that may be targeted to different viewers of the channel 1400 during a given break 1410. Collectively, the assets A-K carried by the asset channels 1401-1404 define a flotilla 1405 that includes assets that may be targeted to different groups of users. The most appropriate assets for a given user may be on different ones of the channels 1401-1404 at different times during the break 1410. These can be delivered to the user by channel hopping during the break with due consideration given to the fact that spots on different channels 1401-1404 may not have the same start and end times. Selection of assets to fill a break of a programming channel, or to fill the available spots within each asset channel of a flotilla may be based on votes of users of the programming channel. That is, assets may be selected by the flotilla constructor 1326 (See FIG. 13) in response to signals received from UEDs 1310 within the network. Such selection may be performed as set forth in co-pending U.S. application Ser. No. 11/332,771, which is incorporated by reference herein.

It is also desirable that each customer premises equipment device be able to navigate across a break selecting assets that are appropriate for the current user. For example, a flotilla may include a number of columns correspondent to a sequence of asset spots for a break. If one column included all assets directed to children, non-children users would be left without an appropriate asset option for that spot. Thus, options for avoiding such situations include making sure that a widely targeted asset is available in each column or time period, or that the union of the subsets defined by the targeting constraints for each asset in a column or time period represents the largest possible subset of the universe of users. Of course, this may conflict with other flotilla construction goals and an optimal solution may need to be arbitrated. In addition, where an issue arises as to which assets to include in a flotilla, the identity of the relevant asset providers may be considered (e.g., a larger volume asset provider or an asset provider who has paid for a higher level of service may be given preference).

To enable the UED to switch to a designated asset channel for a break (or, for certain implementations, between asset options within the flotilla during a break) metadata may be provided in connection with each asset channel(s) and/or programming channel(s). As will be appreciated, each individual asset channel is a portion of an asset stream having a predetermined bandwidth. These asset channels may be further broken into in-band and out-of-band portions. Generally, the in-band portion of the signal supports the delivery of an asset stream (e.g., video). Triggers may be transmitted via the out-of-band portion of a channel. Further, such out-of-band portions of the bandwidth may be utilized for the delivery of the asset option list as well as a return path for use in collecting votes and reporting information from the UED. More generally, it will be appreciated that in the various cases referenced herein where messaging occurs between the UED and a network platform, any appropriate messaging channels may be used including separate IP or telephony channels.

Based on the metadata, the UED may select individual assets or asset sets depending on the implementation. Thus, in certain implementations, the UED may select an asset for the first time-slot of a break that best corresponds to the audience classification of the current user. This process may be repeated for each tine-slot within a break. Alternatively, an asset flotilla may include a single metadata set for each asset channel and the UED may simply select one asset channel for an entire break.

Alternatively, asset options may be provided via a forward-and-store architecture in the case of UEDs with substantial storage resources, e.g., DVRs. In this regard, an asset may be inserted into a designated bandwidth segment and downloaded via the network interface to the storage of the UED. Accordingly, the UED may then selectively insert the asset from the storage into a subsequent break. Further, in this architecture, the assets of the stored options and associated metadata may include an expiration time. Assets may be discarded (e.g., deleted) upon expiration regardless of whether they have been delivered. In this architecture, it will be appreciated that the transmission of assets does not have a real-time component, so the available bandwidth may vary during transmission. Moreover, a thirty second asset may be transmitted in five seconds or over thirty minutes. The available assets may be broadcast to all UEDs with individual UEDs only storing appropriate assets. In addition, due to storage limitations, a UED may delete an asset of interest and re-record it later.

In contrast, in the asset channel architecture, the flotilla is transmitted in synchronization with the associated break and requires little or no storage at the UED. In either case, once an asset from the storage or flotilla is displayed, each UED may provide an asset delivery notification (ADN) to the network platform indicating that the particular asset was delivered. The platform may then provide aggregated or compiled information regarding the total number of users that received a given asset to a billing platform. Accordingly, individual asset providers may be billed in accordance with how many users received a given asset.

B. Dynamic Scheduling

As noted above, the system allows for dynamically inserting assets in support of one or more programming channels based on current network conditions. That is, assets may be selected for programming channels in view of current network conditions as opposed to being selected ahead of time based on expected network conditions. Such a process may ensure that high value air time is populated with appropriate assets. For instance, where current network conditions may indicate that an audience is larger than expected for a current programming period, higher value assets may be utilized to populate breaks. Such conditions may exist when, for example, programming with high asset delivery value and a large expected audience extends beyond a predetermined programming period into a subsequent programming period with low asset delivery value (e.g., a sporting event goes into overtime). Previously, assets directed to the subsequent low value programming period might be aired to the larger than expected viewing audience based on their pre-scheduled delivery times resulting in reduced revenue opportunities. The present system allows for dynamic (e.g., just-in-time) asset scheduling or, at least, overriding pre-scheduled delivery based on changing network conditions.

As noted, signals from the individual UEDs may be utilized for targeted asset system purposes. However, it will be appreciated that while it is possible to receive vote signals from each UED in a network, such full network ‘polling’ may result in large bandwidth requirements. In one alternate implementation, statistical sampling is utilized to reduce the bandwidth requirements between the network and the UEDs. As will be appreciated, sampling of a statistically significant and relevant portion of the UEDs will provide a useful representation of the channels currently being used as well as a useful representation of the most appropriate assets for the users using those channels.

In order to provide statistical sampling for the network, a sub-set of less than all of the UEDs may provide signals to the network platform. For instance, in a first arrangement, each UED may include a random number generator. Periodically, such a random number generator may generate an output. If this output meets a predetermined criteria (e.g., a number ending with 5), the UED may provide a signal to the network in relation to an option list. Alternatively, the platform may be operative to randomly select a subset of UEDs to receive a request for information. In any case, it is preferable that the subset of UEDs be large enough in comparison to the total number of UEDs to provide a statistically accurate overview of current network conditions. However, where a fully representative sampling is not available, attendant uncertainties can be addressed through business rules, e.g., providing a reduced price or greater dissemination to account for the uncertainty.

As noted, a network operator initially provides an asset option list (e.g., list 1010 of FIG. 10) to at least the UEDs within the network that will vote on assets from the list. Generally., the asset option list includes a list of available assets for one or more upcoming breaks. In this regard, it will be appreciated that a platform within the network may be operative to obtain schedule information for all programming channels that have been identified to be supported by targeted assets. The platform may then use the schedule information to communicate with UEDs over the network interface prior to a break. In particular, the platform may be operative to provide the asset option list to UEDs, for example, periodically.

C. Reporting

It would be possible to implement the targeted asset system of the present invention without receiving reports from UEDs indicating which assets, from among the asset options, were delivered to the user(s). That is, although there would be considerable uncertainty as to what assets were delivered to whom, assets could be priced based on what can be inferred regarding current network conditions due to the voting process. Such pricing may be improved in certain respects in relation to ratings or share-based pricing under the conventional asset delivery paradigm. Alternatively, pricing may be based entirely on demographic rating information such as Nielsen data together with a record of asset insertion to build an estimate of the number of users who received an asset. For example, this may work in connection with programming channels that have good rating information.

However, in connection with the UED selection model, it may be desirable to obtain report information concerning actual delivery of assets. That is, because the asset selection occurs at the UED (in either a forward-and-store or synchronized transmission architecture) improved certainty regarding the size and audience classification values for actual delivery of assets can be enhanced by way of a reporting process. The present invention provides an appropriate reporting process and in this regard provides a mechanism for using such report information to enable billing based on guaranteed delivery and/or a goodness of fit of the actual audience to the target audience. In addition to improving the quality of billing information and information available for analysis of asset effectiveness and return on investment, this reporting information provides for near real time (in some reporting implementations) audience measurement with a high degree of accuracy. In this regard, the reporting may be preferred over voting as a measurement tool because reports provide a positive, after-the-fact indication of actual audience size. Accordingly, such information may allow for improved ratings and share data. For example, such data may be licensed to networks or ratings measurement entities.

FIG. 15 illustrates a reporting system 1500 in accordance with the present invention. The reporting system 1500 is operative to allow at least some users of a participating user group, generally identified by reference numeral 1502, to report actual asset delivery. In the illustrated implementation, such report information is transmitted to a network platform such as a headend 1504. The report information may be further processed by an operations center 1506 and a traffic and billing system 1508.

More specifically, report information is generated by individual UEDs 1513 each of which includes a report processing module 1516, an asset selector module 1518 and a user monitoring module 1520. The user monitoring module 1520 monitors inputs from a current user and analyzes the inputs to determine putative audience classification parameter values for the user. Thus, for example, module 1520 may analyze a click stream from a remote control together with information useful for matching a pattern of that click stream to probable audience classification parameter values.

These classification parameters may then be used by the asset selector module 1518 to select an asset or asset sequence from available asset options. Thus, as described above, multiple asset sequences may be available on the programming channel and separate asset channels. Metadata disseminated with or in advance of these assets may identify a target audience for the assets in terms of audience classification parameter values. Accordingly, the module 1518 can select an asset from the available options for delivery to the user (s) by matching putative audience classification parameter values of the user to target audience classification parameter values of the asset options. Once an appropriate asset option has been identified, delivery is executed by switching to the corresponding asset channel (or remaining on the programming channel) as appropriate.

The report processing module 1516 is operative to report to the headend 1504 information regarding assets actually delivered and in some implementations, certain audience classification parameter values of the user (s) to whom the asset was delivered. Accordingly, in such implementations, the report processing module 1516 receives asset delivery information from module 1518 and putative audience classification parameter information for the user (s) from the user monitoring module 1520. This information is used to populate various fields of a report file 1510. In other implementations, audience classification information is not included in the report 1512. However, it may be presumed that the asset was delivered to a user or users matching the target parameters. Moreover, such a presumption may be supported by a goodness of fit parameter included in the report. Thus, audience classification information may be inferred even where the report is devoid of sensitive information.

The report files pass through the headend 1504 and are processed by an operations center 1506. The operations center 1506 is operative to perform a number of functions including processing report information for submission to billing and diagnostic functions as noted above. The operations center 1506 then forwards the processed report information to the traffic and billing system 1508. The traffic and billing system 1508 uses the processed report information to provide measurement information to asset providers with respect to delivered assets, to assign appropriate billing values for delivered assets, and to estimate the target universe in connection with developing new asset delivery contracts.

In order to reduce the bandwidth requirements associated with reporting, a statistical reporting process may be implemented similar to the statistical voting process described above. In particular, rather than having all UEDs report delivery with respect to all breaks, it may be desirable to obtain reports from a statistical sampling of the audience 1502. For example, the UED of each user may include a random number generator to generate a number in connection with each reporting opportunity. Associated logic may be configured such that the UED will only transmit a report file when certain numbers are generated, e.g., numbers ending with the digit “5”. Alternatively, the UED may generate reports only upon interrogation by the headend 1504 or the headend 1504 may be configured to interrogate only a sampling of the audience 1502. Such statistical reporting is graphically depicted in FIG. 15 where users selected to report with respect to a given reporting opportunity are associated with solid line links and deselected users are associated with a broken line links. Moreover, reporting may be batched such that all reports for a time period, e.g., 24 hours or seven days, may be collected in a single report transmission. Such transmissions may be timed, for example, to coincide with low messaging traffic time periods of the network. Also, the reports from different UEDs may be spread over time.

Billing parameters and goodness of fit information may then be determined based on the report information. The billing parameters will generally include information regarding the size of the audience to whom an asset was delivered. The goodness of fit information relates to how well the actual audience matched the target audience of the asset provider. In this regard, a premium may be extracted where the fit is good or a discount or credit may be applied, or over delivery may be provided where the fit was not as good. Based on this information, the T&B system can then generate billing records. It will be appreciated that such billing reflects guaranteed delivery of targeted impressions with compensation for less than optimal delivery.

As noted above, a platform and associated graphical user interface may be provided for receiving asset contract information. As will be described in more detail below, asset providers can use this interface to specify ad campaign information including targeting criteria such as geographic information, demographic information, run-time information, run frequency information, run sequence information and other information that defines asset delivery constraints. Similarly, constraint information may be provided from other sources. This contract information may also include certain pricing information including pricing parameters related to goodness of fit. Moreover, in accordance with the present invention, report information can be utilized as described above for purposes of traffic and billing. All of this requires a degree of integration between the T&B system, which may be a conventional product developed in the context of the conventional asset delivery paradigm, and the targeted asset delivery system of the present invention, which allows for implementation of a novel asset delivery paradigm.

Among other things, this integration requires appropriate configuration of the T&B system, appropriate configuration of the targeted asset delivery system, and a definition of an appropriate messaging protocol and messaging fields for transfer of information between the T&B system and the targeted asset delivery system. With respect to the T&B system, the system may be configured to recognize new fields of traffic and billing data related to targeted asset delivery. These fields may be associated with: the use of reporting data, as contrasted to ratings or share data, to determine billing values; the use of goodness of fit parameters to determine billing parameters; and the use of report information in estimating the target universe for subsequent broadcasts. Accordingly, the T&B system is configured to recognize a variety of fields in this regard and execute associated logic for calculating billing parameters in accordance with asset delivery contracts.

The targeted asset system receives a variety of asset contract information via a defined graphical user interface. This asset contract information may set various constraints related to the target audience, goodness of fit parameters and the like. In addition, the graphical user interface may be operative to project, in substantially real time, an estimated target universe associated with the defined contract parameters. Consequently, integration of the targeted asset delivery system with the T&B system may involve configuring the targeted asset delivery system such that inputs entered via the graphical user interface are mapped to the appropriate fields recognized by the targeted asset delivery system. In addition, such integration may involve recognizing report information forwarded from the targeted asset delivery system for use in estimating the target universe. Generally, the T & B system is modified to included logic in this regard for using the information from the targeted asset delivery system to project a target universe as a function of various contract information entered by the asset provider via graphical user interface.

IV. Exemplary Auction System Impementations

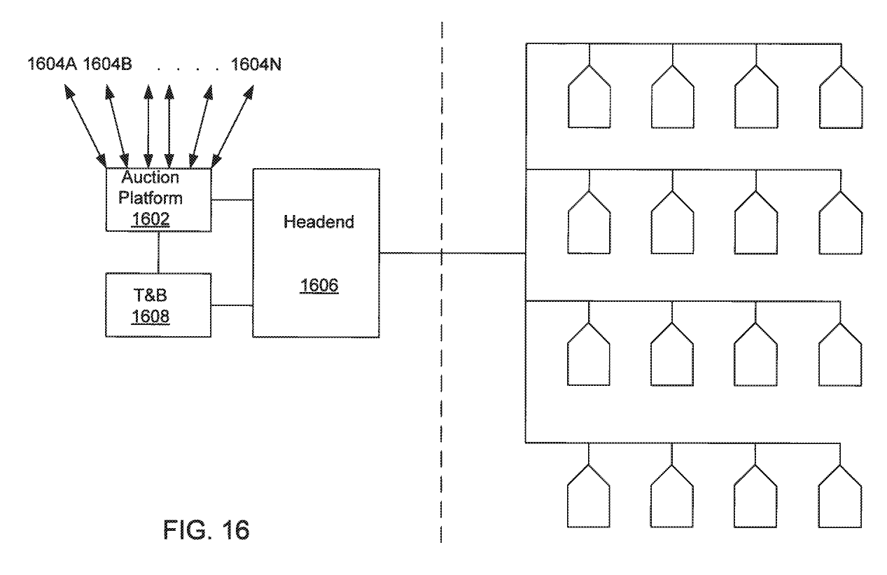

Various combinations of the above-described systems and methods may be utilized to provide an auctioning platform 1602 for use in auctioning asset delivery spots (e.g., avails). See FIG. 16. As shown, the auctioning platform 1602 is accessible by a plurality of asset providers 1604A-N. Such access may be provided using, for example, a graphical user interface, web access, etc. The auctioning platform allows asset providers to bid on asset delivery spots on one or more broadcast channels. The auctioning platform 1602 may allow asset providers to upload content (e.g., assets) to the system such that the content may be inserted into broadcast content. In any case, the auctioning platform 1602 is in communication with a headend 1606 that is operative to implement part of all of the asset targeting systems and methods described above. Further, the auction platform is in communication with a traffic and billing system (T & B System) 1608. The system described herein allows auctioning of specific avails in specific programs or at specific times on specific channels and/or auctioning of viewer impressions. The examples below are assumed to be local spots, that is, that sales are within a particular market area, but the technique generalizes to regional, national and international markets.

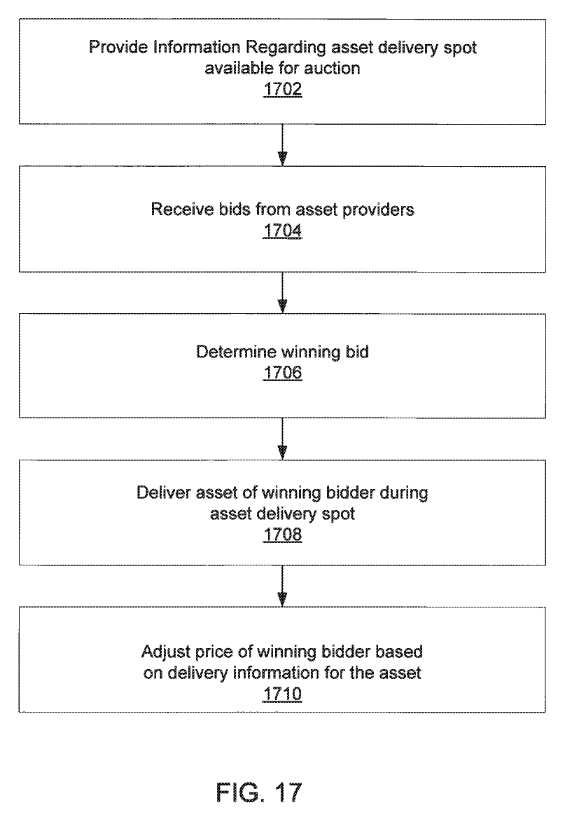

In a first arrangement, a single avail may be auctioned to a single wining asset provider. Initially, information regarding an asset delivery spot is provided 1702. See FIG. 17. In this regard, multiple asset providers may bid 1704 on an asset delivery spot. A winning bidder is then determined 1706. Accordingly, an asset of the winning bidder may be delivered 1708 during the delivery spot. The auction mechanism itself can be a simple highest bidder system. In another arrangement, the auction mechanism may be in the style of a Vickery auction where the highest bidder wins but pays only a penny or other nominal amount more than a second highest bidder. Two examples of auctions where a single avail is provided are set forth:

1. 1^{st} position in 1^{st} break on “Larry King Live” on CNN at 21:00 Jun. 7, 2007

2. 1^{st} position in 2^{nd} break between 22:00 and 23:00 on CNN Jun. 7, 2007

In instances where the asset to be delivered is already available in the system, an auction need only conclude a small amount of time before the break window starts. When the auction concludes, the winning bidder (and in particular the asset associated with the winning bidder) is communicated to a viewlist composer, which in turn arranges for the asset to be inserted into a broadcast content stream. Such insertion may include replacing the default ad in a content stream, transmitting the asset of the winner in separate stream in synchrony with the avail and then causing the DSTB to switch to the appropriate asset channel and/or transmitting instructions to the UED to play a specific asset during the asset delivery spot, where the asset time, has been previously stored on its hard disk. The system may or may not return asset delivery notifications (ADNs) from the UED signifying that the asset has been delivered.

In the above description, a bidder specifies a price for the specific delivery spot and it is presumed that the bidder has knowledge of one or more characteristics of the audience that will be present. An alternative mechanism is to provide audience characteristics such as ratings information along with the description of what is being sold/auctioned. Extending the above two examples:

1. 1^{st} position in 1^{st} break on “Larry King Live” on (CNN at 21:00 Jun. 7, 2006—the national household rating for this program is 1.1

2. 1^{st} position in 2^{nd} break between 22:00 and 23:00 on CNN Jun. 7, 2006—last weeks quarter hour ratings averaged 0.7

A further variation of the auction mechanism that takes advantage of the extra information (e.g., ratings, etc.) allows bidders to bid using familiar price models for advertising sales, for example, cost per thousand (CPM) and cost per point (CPP). in such an arrangement, a bidder may choose to place bids in total cost mode, CPP mode or CPM mode.

To facilitate such conversion, the ratings estimate is presumed to be correct, so that these bids are easily converted from one to another. For example, in an auction mechanism that provides converted bids, instead of bidding $150 for a spot, a bidder may bid $13 CPM (which is based on an audience size that is calculated as number of households reached for a specific operator in the specific market multiplied by rating/100) or a bidder may bid $77 CPP. These three bids may be equivalent.

In a further arrangement, the winning bidder (e.g., the buyer) pays only for the assets that are actually delivered 1710. For instance, using returned ADNs, the actual number of impressions (network users who receive a given asset) may be calculated and the winning bidder may be asked to pay for them proportionally based on the original rating. Such a model may be referred to as “guaranteed impressions.” For example, in a market with 1,000,000 households, all of which are reached by a system operator, a broadcast program is estimated to have a rating of 2.0 (meaning it will reach 20,000 households). If a bidder wins with a bid of $300 for the spot (which in the other methods described would be bidding $150 per point (in CPP mode) or $15 per thousand (in CPM mode) then the bidder may expect to get 20,000 impressions verified by ADNs. What they actually pay is

$300*(actual audience size/20,000)

This model may require the winning bidder to pay more or less than they originally bid for the spot. To provide the winning bidder some certainty, it may be desirable to cap the overage that they would pay. For instance, it may be agreed in advance that a winning bidder will never pay more than, for example, 20% more than their actual bid amount if a bigger audience appears. Further, if the actual audience is within some percentage of the original estimate, for example 5%, then the winning bidder may pay the original estimate. Ratings information may come from an external source like Nielsen or it may be generated using ADNs or votes returned from UEDs, or it could be a combination of such information.

The above discusses placing a single asset into an avail (e.g., asset delivery spot). Of course, this avail could be used for a spot-optimized spot with several targeted alternatives being supplied during the avail because of targeting performed at the UEDs. That is, an advertiser could bid and buy the spot, and then provide three differently targeted assets to be run in the spot with the UEDs of the network users picking the particular asset for the UED of each user for that UED. In such an arrangement, a multi-spot premium that is over and above the bid price may be charged for such a service.

In another arrangement, multiple avails may be auctioned to a single winner. For instance

1. All of the 1^{st} position in 1^{st} breaks on “Larry King Live” on CNN at 21:00 for the week of Jun. 12 to Jun. 18, 2006 (7 Avails) total ratings points 7.7

2. 1^{st} position in 2^{nd} break between 22:00 and 23:00 on CNN for the week starting Jun. 19, 2006—total average rating from last week 4.9

3. 20 breaks (described here . . . ) on Network A in the next week. Average rating for this network is 0.3, with a ratings guarantee of 6.0 rating points.

4. In the week of Jun. 19, 2006 breaks in the following 30 programs (list follows . . . ), which total 20 rating points.

In such an arrangement, the auction may need to conclude before the first break of the group. By grouping several programs together the ratings guarantee mechanism may be more easily implemented as the risks associated with audience variability from day to day can be averaged. As well, by picking a pool of advertising on an unrated network, calculating a likely overall rating, and making a ratings guarantee, becomes less risky.

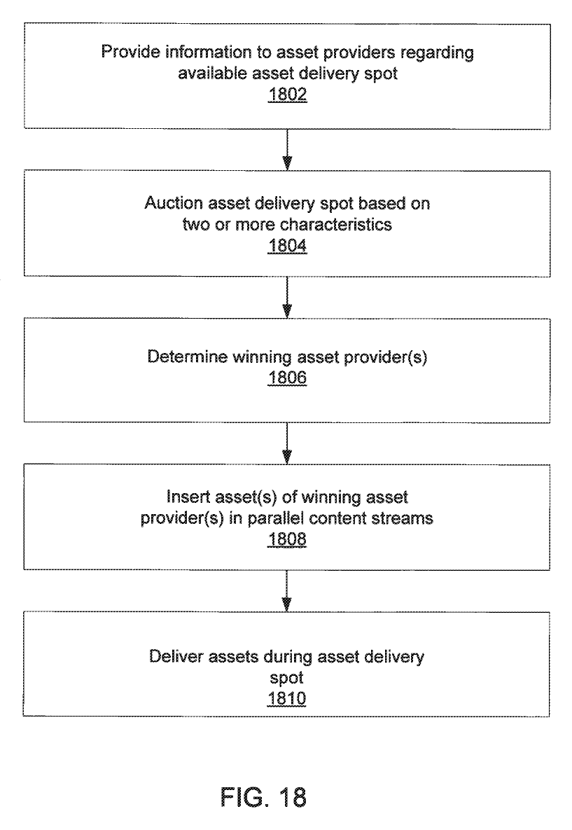

In another arrangement, as illustrated in FIG. 18, a single avail may be auctioned to multiple winners. That is, as the spot optimization system can provide multiple advertising options at one time, those multiple options for a single asset delivery spot may be sold to multiple bidders. Examples of a multiple option single avail auction:

1. 1^{st} position in 1^{st} break on “Larry King Live” on CNN at 21:00 Jun. 7, 2006, two winners each getting 50% of the audience

2. 1^{st} position in 2^{nd} break between 22:00 and 23:00 on CNN Jun. 7, 2006, three winners each getting 33.3% of the audience

Initially, information associated with the avail is provided 1802 to the asset providers. Provision of information may include providing one or more audience characteristics. The asset delivery spot is then auctioned 1804 to the asset providers based on two or more characteristics (e.g., a ½ audience share, demographics, etc.). Winning bidders are determined 1806. Assets of the winning bidders are inserted 1808 into parallel content streams and delivered 1810 during the asset delivery spot (e.g., simultaneously). In this regard, a first asset may be delivered to a first portion of a broadcast audience, and a second asset may be delivered to a second portion of the broadcast audience.

As will be appreciated, multiple options for a single avail require either simultaneous synchronized transmission of the assets or playback from local storage. As discussed above, the UEDs will pick which asset to show based on, for example, a random number generation. For instance, using a random number generator that generates real numbers in the range [0.0,1.0], then given the scenario described in example above, the audience may be split between two different winners. Of course, the auction changes subtly to accommodate multiple winners (e.g., two or more). All of the winners may pay the same amount for their win. Alternatives are that the winners all pay the price determined by the lowest winning bidder, or they pay a penny more than the highest losing bidder.

In a further arrangement, the audience for a specific program may be identified by demographics and each of those demographic may be auctioned separately. This may represent a rating for specific demographic group, rather than a household rating. An example auction would be

1. In 1^{st} position in 1^{st} break on “Larry King Live” on CNN at 21:00 Jun. 7, 2006:
Men 55+—rating 1.2
Women 55+—rating 1.8
Remaining audience—rating 1.0

Here, a bidder would bid on one, or more, of these demographics, which may each be sold in a separate auction. A bidder may choose to compete for more than one of the demographics, and will likely pay a differing amount for each demographic won. Note that in this example the demographics do not overlap. However, this is not an absolute requirement, as a mechanism for randomly assigning a given demographic group to multiple winners with a randomized delivery may be implemented. Such a mechanism may be used to split overlapping demographic categories between winning bidders.

This may further be generalized to split the audience of each program auctioned into, for example, the 16 age/gender ranges that Nielsen uses for demographic rating. Each of these ranges is non-overlapping (the age ranges are 2-11, 12-17, 18-24, 25-34, 35-49, 50-54, 55-64, 65+ and are calculated for both genders). A bidder may compete in separate auctions for each demographic that they are interested in. Note that in many programs the rating for a given category may be zero or nominal, and thus, no auction may take place for such a demographic.

In a further arrangement, a bidder is allowed to specify an all-or-nothing bid. That is, their bid is allowed to be conditional on winning each of their auctions, or even some specified fraction of their bids. This may be dealt with by determining a “potential winner” by deciding if their bid criteria has been met and if not, knocking them out of the auction and elevating the second place bidder in all of the auctions they have been knocked out of. This style of auction may be implemented in a GUI that would allow the bidder to easily place bids and establish various limits across a group of bids.

In another arrangement, multiple avails may be auctioned to multiple winners. For instance, when auctioning off a group of similar avails, it may be desirable to allow bidders the opportunity to bid on subsets of the whole group. In this kind of auction, the avails may be similar. Consider an auction for basketballs. There are 20 for sale; a bidder can bid for as many as they want. This is easy for a bidder. But an auction for 20 balls where there are baseballs, basketballs, golf balls and tennis balls presents a problem for the bidders. In this instance, it may be better to run different auctions for different types of balls. Examples of multiple avails multiple winners auctions:

1. 14 avails in Larry King Live for the week of June 18^{th}. Note that two avails per program are offered. Bidders may bid on any number of avails. Average rating points per avail are 1.1. No impression guarantee provided on purchases of less than 7 avails.

2. 42 prime-time avails on OLN for the week of June 18^{th}. Two avails per hour are offered between 7 pm and 10 pm. Bidders must bid for a minimum of 10 avails to get an impression guarantee.

Again the auction model changes to accommodate multiple winners with the high bidder being allocated their share until all slots are used up. Various pricing mechanisms are possible. Alternatives are that each winner pays what they bid (per avail), all winners pay the same amount per avail that the lowest bidding winner pays, or all winners pay a penny more than the high loser per avail.

In the same manner as described when auctioning a single avails to multiple winners, the demographics for the group of programs may be broken apart and each group auctioned separately. These individual auctions can be run either as single winner auctions (in which case the programs need not be similar) or they can be run as described above with bidders bidding on portions of demographics pools (either by impressions or rating points). In this case, it may be desirable that the programs are similar or have similar audiences. In practice, this may mean groups of the same programs or perhaps large groups of programs on specialty networks.

Example auctions where multiple avails are sold by demographics:

1. 56 avails in Larry King Live for the broadcast month of July 2006 broken into the following demographic groups:
Men 55+—total rating points 67
Women 55+—total rating points 101
Remaining audience—total rating points 56

A bidder may bid for any number of ratings they desire. Further, to facilitate the process, the number of rating points bid for may be exceeded by up to 2 ratings points (i.e. if a bidder bids for 17 points, they may win 19 points).

All of the systems, to the extent that they use ratings information, may get their ratings information from an external source such as Nielsen. An alternative source of ratings information is for the system to use ADNs to build tip a model for program ratings. By monitoring ADNs and the targeting of assets delivered to those audiences it is possible to make inferences about the size and demographics of audiences. These inferences call be accumulated and used to predict program ratings. In another arrangement, a system similar to voting that returns information about the types of people that are currently viewing is used to provide a real-time estimate of the audience for each ad. This information could be used just-in-time to determine auction winners.

Users of this system may not want to manage hundreds of auctions on an auction-by-auction basis. Accordingly, an interface that allows an asset provider to automate the process of finding appropriate auctions and then bidding on them is provided. One component of this system is a search mechanism that helps users find auctions that meet the user's various criteria such as household or demographic rating information, current bid amounts and historical bid amounts. Another component of this system is an automatic bidder that automatically submits bids on specific types of avails. For instance in a system where individual avails are split apart by demographics, the automated bidding system may take bids such as “please bid 150 CPM on any men 18-24 demographics where the rating is between 0.5 and 1.0.”

The core concept for this mechanism is to integrate an aggregation model with a just-in-time auction. The key for an aggregation model is that the asset provider/bidder describes a set of target attributes for consumers that they wish to reach and then the system helps them reach that audience across a group of channels 24 hours a day (or other time frame as set forth by the bidder).

A bidder begins the purchase process by using a GUI (or other system-to-system interface) to specify the parameters for an aggregated auction offer. The parameters for an offer allow the auction system to make automatic bids on behalf of bidders. The parameters include:

1. Targeting criteria—many different targeting mechanisms may be used. A given ad insertion implementation may support only a subset (or a superset) of the following:
UED classified age and gender
UED classified household income
Start and end time and date for campaign
Time of day limitations
Day of week limitations
Geographic restrictions
Household tags (determined using UED identifier lists from the headend that directs the UED to select a particular ad or type of ad)
Network inclusions and exclusions
Program rating inclusions and exclusions
Program title word inclusions and exclusions
Keyword searches
Commodity codes
Minimum separation

2. Maximum impressions—an asset provider specifies a total number of impressions that they want to buy. Once this total is reached the offer is deem fulfilled and automatic bidding stops.

3. Maximum price per impression—an asset provider specifies the maximum amount of money that the automatic bidding system should bid per impression.

4. Maximum cost—an asset provider specifies the maximum amount of money that the buyer is prepared to pay for the contract. Once this amount of money has been expended on the campaign, the offer is deemed fulfilled and automatic bidding stops.

5. Pacing—the asset provider nay specify pacing constraints that specify the maximum amount of money the provider is willing to pay for a given time period. These can be specified as daily, weekly or monthly pacing amounts. In any given time period if the specified total is reached then automatic bidding is suspended until the next period starts.

Note that all of the above may be changed at any time, although there may be a delay in implementing some of the changes. For instance, in a given system it might take up to 24 hours to make changes to targeting whereas updates to maximum price per impression might take effect nearly instantly. Other changes might take effect only once per day at a given time of day (for instance changes to pacing may take effect at 2 am each morning). A given campaign may also be suspended and resumed (that is, automatic bidding stops until the campaign is resumed).

Asset providers bid on targeted impressions to be delivered to audiences. These impressions may be sold by running an automatic auction before each break occurs on a network for which auctioning insertion is supported. In general, an asset provider will need to win a number of auctions to satisfy their impression goals. Each asset provider may enter the auction for each possible avail or asset providers may elect to enter only selected auctions.

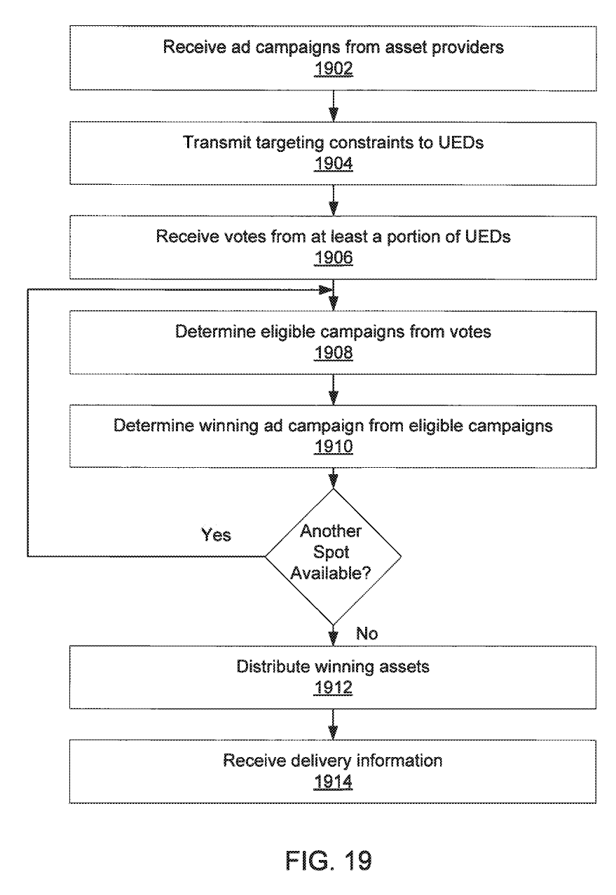

One process for implementing the just-in-time automated auction is provided in relation to FIG. 19. Initially, the auction platform receives 1902 and campaigns from asset providers. These campaigns may be received over a considerable period of time and/or on an ongoing basis. On a periodic basis, a list of the targeting constraints for all of the active campaigns is transmitted 1904 to all UEDs in the system. The set of constraints that are transmitted to the UEDs include those constraints that can only be evaluated in the UEDs. Shortly before the break window for an avail on a given network occurs the system asks UEDs to “vote.” At least a statistical sample of UEDs tuned to the network in question submit votes that list one or more, e.g., the complete set of campaigns that the UEDs matches at the moment of the vote. The auctioning platform collates the votes that are received 1906 from the UEDs.

The system may evaluate some of the targeting criteria in the head-end and/or auctioning platform and determine 1908 that certain campaigns are not eligible to be played even though some UEDs vote for them (for instance, program rating exclusion might be determined only in the head-end). Votes for these campaigns are eliminated. The size of audience for each eligible campaign is estimated from the collated votes and the voting sampling criteria. The auction system uses the information from the audience size estimation and the offer parameters to determine 1910 the winner of the auction. A price per impression is also determined if an additional parallel distribution opportunity is available, then all votes which include the winning campaign from the previous step are eliminated, the remaining votes are recollated and steps 1906 to 1910 are repeated until there are no remaining distribution opportunities. In one arrangement, the price per impression for all of the winning bids is adjusted (e.g., based on a Vickery style auction).

Provisional updates to the impression totals, and cost totals for all of the winning campaigns are accounted for. All of these provisional updates are tracked in a manner that allows them to be “backed out.” When the cue signal arrives the set of assets associated with the winning campaigns are distributed 1912 in synchronized parallelism with the avail. Each UED tuned to the channel picks an ad for insertion, and then each UED, or a statistical sample of UEDs, reports which of the assets that it delivered to the headed (e.g., Asset Delivery Notifications or ADNs). The winning bidders may then be charged based on the actual number of impressions that were delivered. To do this, the actual number of impressions delivered is multiplied by the cost per impression calculated for this campaign during the auction. The provisional update for each winning campaign is backed out and the actual impression count and costs are used to update the totals.

The noted automated auctioning mechanism uses a voting mechanism to estimate the size of an audience. As a UED evaluates all of the UED dependent parameters to determine a match, each vote provides a very accurate estimate of the campaign matching the UED audience for the impending break. However, there are alternative mechanisms that could provide an estimate of the size of audience for a particular campaign for an upcoming break. The accuracy of these mechanisms will depend on the set of targeting mechanisms available in the system. Alternatives include:

1. Use external data sources that include television ratings and census data

2. Use historical ADN data to build up a statistical model of viewership

3. Operate the voting system to periodically survey the system for information about current viewers (as opposed to eligible campaigns). To differentiate this mechanism from voting we will call this a “UED census”

Alternate Mechanism for Determining Price

As described, the automated auctioning mechanism provides a system that charges winning bidders only for actual advertising that was delivered. This mechanism provides a very accurate charging mechanism. However, in practice the estimate system employed in the voting step may accurately estimate audience size, particularly if the re-voting mechanism described below is employed. In this instance the delivery notification system need not be implemented and the voting estimate may be used in the final price computations.

As described above, voting can return a binary match Yes/No match indication. Some of the targeting mechanisms do have binary resolutions (for instance those based on geography), however other mechanisms (for instance the age and gender of the current audience that is determined by a classifier system) have probabilistically determined match criteria. Another voting mechanism is to return the probability (i.e., goodness of fit) that a particular campaign matches. The list that is returned might include a probability for each campaign, or it might return indications for only those campaigns where the probability exceeds a given threshold. Collating the probabilistic votes may be done in a statistical manner that generates a probability distribution describing the likelihood of the size of an audience for each campaign that was voted for. Likewise that distribution may be used to calculate an expected value for the revenue that would be derived from each campaign.

As the time between voting and the actual insertion of advertising increases, so increases the likelihood that the size and character of the audience has changed. If the difference is only a few minutes (e.g., 2 or 3 minutes), and there hasn't been a program change, then the difference is probably small. If, on the other hand, the difference if 15 or 20 minutes it is quite likely that there has been a substantial change. Two alternatives are presented for dealing with the change of audience. The first is to build a probability model of the how an audience changes over time, and use techniques such a non-linear filtering to predict the likely changes in the audience. A second alternative is to periodically (for instance every 5 minutes) carry out a revote, and if the result of the new vote is substantially different from the previous vote carry out a new auction. Some care needs to be taken to avoid conditions where the actual break happens during the re-vote and re-auction process. In such an instance where a break occurs before a re-auction is completed, previous auction results may be utilized to identify winning bidders and select assets for insertion.

When multiple simultaneous assets are provided to a UED or UED at one time, the UED must pick one of these assets to deliver. Alternatives for selecting assets include first match and best match. In first match mode, asset choices are ordered in the same order in which their respective auctions were won and then the UED selects the first one that is a reasonable match. In best match mode, the UEDs current estimate for a best match among the alternatives is chosen.

The auction platform is responsible for determining the winner or winners of each auction and the price that each winning bidder should pay. In circumstances where there are multiple winners it may be desirable to incrementally determine winners and then determine the price that they pay after all winners have been determined.

The auctions described in relation to specific avails take place over a period of time and allow a bidder to change a bid during the course of the auction. This is because the goods being sold (the avails) can be determined ahead of time. However, in the case of auctions run in aggregation mode, this may not be possible because the number of real-time viewers is a critical component in the description of the audience, and that number is not known until a very short period of time before the asset is distributed. Complicating matters further, when multiple positions are being auctioned, the number of viewers for a given position may be highly dependent on viewers for the other positions. Consider the following example:

Positive votes are indicated with an X:

| | Asset 1 | Asset 2 | Asset 3 | Asset 4 |
|---|---|---|---|---|
| UED A | X | | X | |
| UED B | X | | | X |
| UED C | | X | X | |
| TOTAL | 2 | 1 | 2 | 1 |

If the bidder owning Asset 1 wins the auction then Asset 3 is reduced to only one vote and Asset 4 has no votes. If on the other hand the bidder owning Asset 3 wins the auction then Asset 2 is reduced to no votes and Asset 1 is reduced to one vote. The important observation is that the auction for the second position (e.g., parallel distribution) changes quite dramatically. The consequence of this observation is that the auction typically runs entirely in an automated mode, and that the bidders may not have an opportunity to change their bids during the bidding process (although they may be able to change there bids up to the moment that the auction is conducted).

In the descriptions of voting models the following two vote tabulations will be used (a 1 is used to indicted a positive vote). These votes represent 5% of the UED population:

Scenario 1
Votes for Assets

| | | A | B | C | D | E |
|---|---|---|---|---|---|---|
| UED | 1 | 1 | 1 | 1 | 1 | 1 |
| | 2 | 1 | | | | 1 |
| | 3 | 1 | 1 | 1 | 1 | 1 |
| | 4 | | 1 | 1 | | |
| | 5 | | | 1 | | 1 |
| | 6 | | | | 1 | |
| | 7 | | 1 | 1 | | |
| | 8 | | 1 | 1 | | 1 |
| | 9 | 1 | | | 1 | 1 |
| | 10 | 1 | | 1 | | 1 |
| | 11 | | 1 | 1 | | |
| | 12 | 1 | 1 | | 1 | 1 |
| | 13 | | | 1 | | 1 |
| | 14 | 1 | 1 | 1 | | 1 |
| | 15 | | | 1 | 1 | |
| TOTAL | | 7 | 8 | 11 | 6 | 10 |

The following vote tabulation supposes the winning bid specified asset C and therefore all votes associated with asset C are removed and new total computed.

Scenario 1
Votes for Assets AFTER C is removed

| | | A | B | C | D | E |
|---|---|---|---|---|---|---|
| UED | 1 | | | | | |
| | 2 | 1 | | | | 1 |
| | 3 | | | | | |
| | 4 | | | | | |
| | 5 | | | | | |
| | 6 | | | | 1 | |
| | 7 | | | | | |
| | 8 | | | | | |
| | 9 | 1 | | | 1 | 1 |
| | 10 | | | | | |
| | 11 | | | | | |
| | 12 | 1 | 1 | | 1 | 1 |
| | 13 | | | | | |
| | 14 | | | | | |
| | 15 | | | | | |
| TOTAL | | 3 | 1 | 0 | 3 | 3 |

In the following descriptions the term legal bid or legal offering is used to describe a bid that does not violate a bidder's complete bid, which includes the total amount they are willing to pay and any constraints that they have made. For instance, if a bidder has said the maximum that they are willing to pay for an ad campaign is $1,000 and they have already accumulated $990 in advertising, then any subsequent bid of less than or equal to $10 is legal, but any larger bid is not. One novel consequence of this auction model is that all campaigns compete for every avail, and in particular, multiple campaigns for the same bidder may end up bidding against each other. Special rules may be implemented to prevent this from happening. In particular, once a particular buyer wins a bid, then for the current auction other bids from that buyer could be considered illegal.

All of these auction models are described assuming that there is only one parallel content distribution available in a given avail (i.e. a flotilla with only one column). However, it will be appreciated that multiple parallel distribution may be available.

High Bidder Wins

For each asset an offering price is calculated as follows: the maximum bid for an asset is multiplied with the estimated audience size. The largest legal offering price wins the auction. In the case of a tie, one of the bidders may be picked at random or another tie-breaking mechanism may be implemented. The price per impression paid is the maximum bid price.

The following example takes the total from the scenario 1 votes and supposes a range of bids (on a cost per impression (CPI) basis) and determines the winner. Note that since the assumption in this example is that 5% of the set tops vote the estimated audience is 20 times this total vote for each asset. The bidder associated with asset C wins and pays a CPI of $0.30:

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI BID | 0.30 | 0.25 | 0.30 | 0.10 | 0.25 |
| Offering Price | $42.00 | $40.00 | $66.00 | $12.00 | $50.00 |
| WINNER | | | WINS | | |

An alternative set of CPIs can yield a different winner, the bidder associated with asset D who will pay a CPI of $0.60:

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI BID | 0.30 | 0.25 | 0.30 | 0.60 | 0.25 |
| Offering Price | $42.00 | $40.00 | $66.00 | $72.00 | $50.00 |
| WINNER | | | | WINS | |

This auction is repeated for each parallel distribution opportunity and there is no adjustment in price.

After C wins in the first example in this section, the votes are recounted and the following determines the second winner, which in this case is the Asset A owner who will pay a CPI of $0.30

| | Asset | | | | |
|---|---|---|---|---|---|
| | A | B | C | D | E |
| Total Vote | 3 | 1 | 0 | 3 | 3 |
| Estimated Audience | 60 | 20 | 0 | 60 | 60 |
| CPI BID | 0.30 | 0.25 | 0.30 | 0.10 | 0.25 |
| Offering Price | $18.00 | $5.00 | $— | $6.00 | $15.00 |
| WINNER | WINS | | | | |

High Bidder Wins, Vickery Pricing

For each asset an offering price is calculated as follows: the maximum bid associated with the asset is multiplied with the estimated audience size. The largest legal offering price wins the auction, and, in the case of a tie, one of the bidders may be picked at random or another basis, or the avail may be split. The estimated total price that they will pay is one penny more than the next highest legal bid. The winning price per impression is calculated by dividing the estimate total price by the estimated size of the winning bids audience.

Using the votes for scenario I as an example, the winner is again the owner of Asset C. However the amount they will pay is $50/220=$0.227 CPI.

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI BID | 0.30 | 0.25 | 0.30 | 0.10 | 0.25 |
| Offering Price | $42.00 | $40.00 | $66.00 | $12.00 | $50.00 |
| WINNER | | | WINS | | |

This auction is repeated for each parallel distribution opportunity and there may be no adjustment in price.

High Bidder Wins, All Pay Same Total Price

For each asset an offering price is calculated as follows: the maximum bid associated with the asset is multiplied with the estimated audience size. The largest legal offering price wins the auction. Final price calculation may be done after all winners for a given flotilla are decided.

The auction is repeated for each parallel distribution opportunity. Once all winners have been determined then the price paid by the lowest winning bidder is used as the estimated price. The winning price per impression for each bidder is calculated separately for each as by dividing the estimated price by the estimated size of each winning bids audience.

Applying this method to the votes of scenario 1, and assuming a parallel distribution opportunity for 2 simultaneous assets, then the winners will be the owners of Assets A and C. Each will pay the price equivalent to $18. The owner of A will pay $18/220=$0.0818 CPI and the owner of A will pay what they bid $0.30.

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI BID | 0.30 | 0.25 | 0.30 | 0.10 | 0.25 |
| Offering Price | $42.00 | $40.00 | $66.00 | $12.00 | $50.00 |
| WINNER | | | WINS | | |

And the second auction after C is removed.

| | Asset | | | | |
|---|---|---|---|---|---|
| | A | B | C | D | E |
| Total Vote | 3 | 1 | 0 | 3 | 3 |
| Estimated Audience | 60 | 20 | 0 | 60 | 60 |
| CPI BID | 0.30 | 0.25 | 0.30 | 0.10 | 0.25 |
| Offering Price | $18.00 | $5.00 | $— | $6.00 | $15.00 |
| WINNER | WINS | | | | |

High Bidder Wins, All Pay Same Price Per Impression

For each asset an offering price is calculated as follows: the maximum bid associated with the asset is multiplied with the estimated audience size. The largest legal offering price wins the auction, in the case of a tie, one of the bidders is picked at random. Final price calculation may be done after all winners for a given flotilla are decided. The auction is repeated for each parallel distribution opportunity. Once all winners have been determined then the lowest price paid per impression by a winning bidder is the winning price per impression for each bidder.

Applying this to vote scenario 1, and assuming a parallel distribution opportunity for 2 simultaneous assets, then the winners will be the owners of Assets A and C. Each will pay the CPM associated with the lowest winner, which in this case is $0.30.

| | Asset | | | | |
|---|---|---|---|---|---|
| | A | B | C | D | E |
| Total Vote | 7 | 8 | 11 | 6 | 10 |
| Estimated Audience | 140 | 160 | 220 | 120 | 200 |
| CPI BID | 0.30 | 0.25 | 0.30 | 0.10 | 0.25 |
| Offering Price | $42.00 | $40.00 | $66.00 | $12.00 | $50.00 |
| WINNER | | | WINS | | |

And the second auction after C is removed.

| | Asset | | | | |
|---|---|---|---|---|---|
| | A | B | C | D | E |
| Total Vote | 3 | 1 | 0 | 3 | 3 |
| Estimated Audience | 60 | 20 | 0 | 60 | 60 |
| CPI BID | 0.30 | 0.25 | 0.30 | 0.10 | 0.25 |
| Offering Price | $18.00 | $5.00 | $— | $6.00 | $15.00 |
| WINNER | WINS | | | | |

The preceding auction discussions assume only one parallel distribution alternative within an avail (break). In general, there will be more than one. A separate auction should be run for each flotilla column, although it should be noted that the pool of votes may need to be updated for the subsequent breaks after an asset is placed (minimum separation rules will usually prevent the same asset from being delivered twice in a row). Commodity code rules may also make some assets “illegal” after another ad has been place. One way to run an auction is to sell the contents of each column in a sequential fashion. However, an alternative mechanism is to sequentially auction all of the first positions in each column, then auction the second positions proceeding in this fashion until all positions have been sold.

Considerable historical information about auctions accumulates quickly. This information can be used to assist a bidder in making their bids. For instance, historical information about all previous campaigns that match the targeting of a newly created campaign can be retrieved. This information can suggest the average number of impressions that are available for a given type of campaign on a daily basis (as well as the total number of impressions that are available on a daily basis). Average cost per impression for similar campaigns can also be retrieved. Aggregate information about current campaigns can also be retrieved and the demand for impressions can be calculated. This demand can be compared with the historical demand and prices to produce a rough estimate of what current prices are likely to be.

When a bidder is entering a new campaign they may request (e.g., via an interface) the system to provide historical information and/or for estimates of prices and available impressions. This information could then guide the bidder in the number of impressions that they are likely able to get over a given time period and suggest a bidding range that would likely get them that amount impressions. Of course, the system can only provide estimates since external force may increase demand unexpectedly, or supply may reduce or any number of factors may invalidate the estimate. For this reason it may be important that buyers be able to update their bidding parameters as their campaigns progress.

Campaign Monitoring

While a particular campaign is active for a bidder several pieces of information can be made available to them.

Examples of available information include:

Cumulative count of impressions for the campaign

Daily, weekly and monthly impression counts for the campaign since it started and, if appropriate, a comparison to goals associated with pacing budget

Current status of the budget, both spent and remaining funds, and similar status for pacing budgets

Daily, weekly and monthly total costs for the campaign since it started and, if appropriate, a comparison to pacing budgets.

Detailed information about all auctions won.

Detailed information about auctions that were lost, provide some information about the winning bids (estimates audience sizes and impression costs).

Average number of total impressions delivered by the system per day, week and month

Detailed day-by-day, week-by-week and month-by-month total impressions delivered by the system.

Average number of total impressions delivered by the system per day, week and month for commonly purchased targets. For instance, the most commonly bought age and gender targets or most commonly purchased geographic areas.

Detailed day-by-day, week-by-week and month-by-month total impressions delivered by the system for commonly purchased targets.

The information provided to bidders can be delivered in a number of different formats. Some of these formats may be more appropriate for some kinds of data.

Tabular format

Spreadsheets

Graphs

There are numerous different ways in which data may be delivered to winning bidders by the system. Some of these mechanisms include users accessing data interactively via the internet using a web browser. This manner of interactive access would allow users to search for specific historical data if it is useful to them. Users can also receive periodic email messages that summarize the status of their campaign. One manner in which these reports can be made available is to provide a menu of standard report types that a user can request be emailed to them. Of course an option that provides for fully customized reports can also be supported. Users can also request that periodic fax summaries by sent to them. Further, users can request that periodic paper reports be mailed to them. Some buyers may be competing with several different campaigns at once. Additional summary information that presents the overall status of all, or various subsets, of their active campaigns can be summarized and made available to them.

While various embodiments of the present invention have been described in detail, further modifications and adaptations of the invention may occur to those skilled in the art. However, it is to be expressly understood that such modifications and adaptations are within the spirit and scope of the present invention.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for use in connection with delivering assets to users of a broadcast network, the broadcast network primarily involving synchronized distribution of broadcast content to multiple users, the method comprising:
providing information regarding an available asset delivery spot for delivering content;
receiving bids for said asset delivery spot, wherein said bids are received from one or more asset providers;
based on a winning bid, inserting an asset of one of the asset providers into the a content stream of the broadcast network for delivery during said asset delivery spot; and
adjusting a payment associated with the winning bid based on information regarding deliveries of said asset to users of the broadcast network.

2. The method of claim 1, wherein providing comprises providing network channel information and delivery time information for said asset delivery spot.

3. The method of claim 1, wherein providing further comprises:
providing ratings information for said asset delivery spot.

4. The method of claim 2, wherein said ratings information is provided for at least a first characteristic of a network users receiving the available asset delivery spot.

5. The method of claim 1, wherein providing comprises providing ratings information for at least first and second different demographic groups of network users.

6. The method of claim 1, wherein providing comprises providing at least one audience classification parameter for said asset delivery spot.

7. The method of claim 6, wherein said audience classification parameter relates to at least one of age, gender, income, geographic locale of a portion of an audience segment of interest.

8. The method of claim 1, wherein receiving said bids comprises interactively receiving bids from one or more user interfaces associated with one or more asset providers.

9. The method of claim 1, wherein receiving bids further comprises:
receiving predefined ad campaigns from one or more asset providers, said ad campaigns having one or more targeting criteria and bid information; and
correlating said targeting criteria and said bid information of said predefined ad campaigns with the information regarding an available asset delivery spot to identify a winning bid.

10. The method of claim 9, wherein correlating is an automated process.

11. The method of claim 10, wherein said winning bid is determined during a program that includes the asset delivery spot.

12. The method of claim 1, wherein inserting comprises:
replacing a default asset in the content delivery stream with the asset associated with the winning bid.

13. The method of claim 1, wherein, inserting comprises:
transmitting instructions to at least a portion of UEDs within the broadcast network to play the asset associated with the winning bid during said asset delivery spot, wherein said asset has previously been stored in storage associated with said UEDs.

14. The method of claim 1, wherein inserting comprises:
inserting the asset associated with the winning bid into a parallel content stream that is broadcast in synchrony with a content stream including the asset delivery spot.

15. The method of claim 14, further comprising:
providing information to at least a portion of UEDs in said broadcast network regarding the availability of said asset on said parallel content stream, wherein the information includes at least one target criteria for said asset.

16. The method of claim 1, further comprising:
based on a second winning bid, inserting a second asset of one of the asset providers into the a second content stream of the broadcast network for delivery during said asset delivery spot.

17. The method of claim 1, further comprising:
receiving asset delivery notifications from at least a portion of UEDs in the broadcast network, said asset delivery notifications providing indication of actual deliveries of said asset to network users.

18. The method of claim 17, wherein said winning bid is adjusted based on said actual deliveries.

19. The method of claim 1, wherein said winning bid comprises the highest bid for said asset delivery spot.

20. The method of claim 19, wherein said winning bid is adjusted to a nominal amount more than the second highest bid.

21. A method for use in connection with delivering assets to users of a broadcast network, the broadcast network primarily involving synchronized distribution of broadcast content to multiple users, the method comprising:
auctioning an asset delivery spot of a broadcast program for broadcast to a network audience, wherein said auctioning is based on at least first and second audience characteristics;
inserting first and second assets associated with winning bids for said first and second audience characteristics into at least one content stream of the broadcast network; and
delivering, via said broadcast network, said first asset to a first portion of the network audience of said broadcast program during said asset delivery spot;
delivering, via said broadcast network, said second asset to a second portion of the network audience of said broadcast program during said asset delivery spot.

22. The method of claim 21, wherein said first and second assets are delivered simultaneously.

23. The method of claim 21, wherein said first and second assets are delivered on separate broadcast content streams.

24. The method of claim 21, wherein auctioning comprises:
performing a first auction for said first audience characteristic; and
performing a second auction for said second audience characteristic.

25. The method of claim 21, wherein auctioning comprises:
providing information regarding said asset delivery spot; and
receiving bids for said asset delivery spot, wherein said bids are received from one or more asset providers.

26. The method of claim 25, wherein providing information further comprises:
providing ratings information for said asset delivery spot.

27. The method of claim 26, wherein said ratings information is provided for at least first and second different demographic groups of network audience.

28. The method of claim 21, wherein said audience characteristics relate to at least one of age, gender, income, geographic locale of a portion of an audience segment of interest.

29. The method of claim 21, wherein inserting comprises:
replacing a default asset in the content delivery stream with one of the first and second assets and inserting the other of the first and second assets into a parallel content stream.

30. The method of claim 29, wherein, inserting comprises:
transmitting instructions to at least a portion of UEDs within the broadcast network to play one of the first and second assets during said asset delivery spot, wherein said first and second assets have previously been stored in storage associated with said UEDs.

31. The method of claim 31, wherein inserting comprises:
inserting the first and second assets into first and second parallel content streams that are broadcast in synchrony with a content stream including the asset delivery spot.

32. The method of claim 31, further comprising:
providing information to at least a portion of UEDs in said broadcast network regarding the availability of said first and second assets on said parallel content streams, wherein the information includes at least one target criteria for each said asset.

33. The method of claim 32, wherein delivering said first and second assets comprises:
allowing UEDs of said broadcast network to select one of the first and second assets for delivery during said asset delivery spot based on said target criteria.

34. The method of claim 21, wherein delivering comprises:
allowing UEDs of said broadcast network to randomly select one of the first and second assets for delivery during said asset delivery spot.

35. The method of claim 21, further comprising:
receiving asset delivery notifications from at least a portion of UEDs in the broadcast network, said asset delivery notifications providing indication of actual deliveries of said first and second assets to said first and second portions of said network audience.

36. The method of claim 21, further comprising:
adjusting payments associated with the winning bids based on information regarding deliveries of said first and second assets to said network audience.

37. The method of claim 21, wherein auctioning further comprises:
receiving predefined ad campaigns from asset providers, said ad campaigns having one or more targeting criteria and bid information; and
correlating said targeting criteria and said bid information of said predefined ad campaigns with information regarding said asset delivery spot to identify said winning bids.

38. The method of claim 37, wherein correlating is an automated process.

39. The method of claim 37, wherein said winning bids are determined during a program that includes the asset delivery spot.

40. A method for use in connection with delivering assets to users of a broadcast network, the broadcast network primarily involving synchronized distribution of broadcast content to multiple users, the method comprising:
offering a predetermined number of audience impressions for an audience having at least one predefined targeting criteria;
receiving bids for said audience impressions from one or more asset providers; and
delivering an asset of a winning asset provider to network users having said at least one defined targeting criteria.

41. The method of claim 40, wherein said asset is delivered until said predetermined number of said audience impressions is achieved.

42. The method of claim 41, wherein delivering comprises:
delivering said asset at two or more temporally distinct times.

43. The method of claim 41, wherein delivering comprises:
delivering said asset on two or more different network channels.

44. The method of claim 40, wherein delivering comprises:
delivering said asset to said predetermined number of said network users within a predefined time frame.

45. The method of claim 40, wherein said targeting criteria relates to at least one of age, gender, income, geographic locale of a portion of an audience segment of interest.

46. The method of claim 40, wherein receiving said bids comprises interactively receiving bids from one or more user interfaces associated with one or more asset providers.

47. The method of claim 40, wherein receiving bids further comprises:
receiving predefined ad campaigns from one or more asset providers, said ad campaigns having one or more targeting criteria and bid information; and
correlating said targeting criteria of said predefined ad campaigns with the targeting criteria for said predetermined number of audience impressions to identify a winning bid of said winning asset provider.

48. A method for use in connection with delivering assets to users of a broadcast network, the broadcast network primarily involving synchronized distribution of broadcast content to multiple users, the method comprising:
obtaining at least one audience characteristic for an upcoming asset delivery spot in a broadcast content stream;
identifying ad campaigns having targeting criteria corresponding with said at least one audience characteristic;
determining a winning ad campaign from said identified ad campaigns; and
delivering an asset associated with said winning ad campaign during said asset delivery spot.

49. The method of claim 48, further comprising:
adjusting at least one parameter of said winning ad campaign based on said delivering of said assert.

50. The method of claim 49, wherein said at least one parameter relates to a number of delivered impressions for said winning ad campaign.

51. The method of claim 49, wherein said at least one parameter relates to costs for said winning ad campaign.

52. The method of claim 48, further comprising:
obtaining information regarding a number of network users who received said asset.

53. The method of claim 52, further comprising:
calculating a cost for delivering said asset during said asset delivery spot based at least in part on said number of network users who received said asset.

54. The method of claim 53, wherein calculating said cost comprises multiplying said number of network users who received the asset with a bid price associated with said winning ad campaign.

55. The method of claim 52, wherein obtaining information comprises:
obtaining statistical information associated with delivery of said asset to said network users.

56. The method of claim 52, wherein obtaining information comprises:
obtaining reports from UEDs of network users who received said asset.

57. The method of claim 48, wherein obtaining at least one audience characteristic includes obtaining information relating to audience size.

58. The method of claim 48, wherein obtaining at least one audience characteristic includes obtaining information relating to audience demographics.

59. The method of claim 48, wherein identifying further comprises identifying ad campaigns having temporal targeting criteria corresponding with a time associated with said asset delivery spot.

60. The method of claim 48, wherein identifying further comprises identifying ad campaigns having programming targeting criteria corresponding with programming associated with said asset delivery spot.

61. The method of claim 48, wherein determining the winning ad campaign comprises:
multiplying a bid price associated with each ad campaign with an estimated audience for said asset delivery spot to determine an offering price for each ad campaign; and
selecting at least one winning ad campaign based on said offering price.

62. The method of claim 61, wherein said estimated audience is separated into different estimated audiences by demographic group and different ad campaigns may be multiplied by said different estimated audiences to determine said offering price for each ad campaign.

63. The method of claim 48, wherein said winning ad campaign is determined during a program that includes the asset delivery spot.

64. A system that delivers assets to users of a broadcast network, the broadcast network primarily involving synchronized distribution of broadcast content to multiple users, the system comprising:
a network interface for receiving ad campaign information from asset providers;
an auctioning processor that processes said ad campaign information to identify a winning ad campaign for at least a first asset delivery spot;
a content synchronizer that, when directed by the auctioning processor, delivers an asset associated with the winning ad campaign to users of the broadcast network; and
a traffic and billing module that calculates a value for the delivery of the asset based on the delivery of the asset to the users of the broadcast network.

65. The system of claim 64, wherein delivery of the asset includes an insertion of the asset into a stream of programming associated with said asset delivery spot.

66. The system of claim 64, wherein delivery of the asset includes an insertion of said asset into a content stream that is broadcast in synchrony with a content stream including programming containing said asset delivery spot.

67. The system of claim 64, wherein said auctioning processor is operative to interactively receive ad campaign information form said asset providers during an auction.

68. The system of claim 64, wherein said auctioning processor is operative to utilize predetermined ad campaign information to determine one or more winning ad campaigns for said asset delivery spot.

69. The system of claim 64, wherein said traffic and billing module is operative to receive asset delivery reports from customer premise equipment of users of the broadcast network.
